(19) United States
(12) Patent Application Publication
(10) Pub. No.: US 2009/0037151 A1
(43) Pub. Date: Feb. 5, 2009

(54) SYSTEM AND METHOD OF BINDING ENERGY FOR POLYMER MOLECULE

(75) Inventor: Shirun HO, Tokyo (JP)

Correspondence Address: MATTINGLY, STANGER, MALUR & BRUNDIDGE, P.C., 1800 DIAGONAL ROAD, SUITE 370, ALEXANDRIA, VA, 22314, US

(73) Assignee: Hitachi, Ltd.

(21) Appl. No.: 12/181,823

(22) Filed: Jul. 29, 2008

(30) Foreign Application Priority Data
Jul. 31, 2007 (JP) 2007-198749

(51) Int. Cl. G06F 17/50; G06G 7/60

(52) U.S. Cl. 703/1; 703/11

(57) ABSTRACT

Provided is a design method of binding energy for polymer molecule, including: receiving a reference binding structure of a complex including a protein in a hydration state and a compound; setting an optimum structure of an unbound protein in a solution; searching for a local minimum value in a binding energy in a search region after removing the water molecules from the protein, and selecting N^{h} candidate binding structures; adding the removed water molecules, carrying out structure optimization for the compound, protein, and complex in the solution, and selecting N^{S} candidate binding structures; calculating entropy in the solution for the candidate binding structures for which the structure optimization for the protein and the compound in the solution has been carried out for the selected candidate binding structures; and determining a complex structure having a minimum free energy, which is a sum of the binding energy and an entropy energy.

### CLAIM OF PRIORITY

The present application claims priority from Japanese application P2007-198749 filed on Jul. 31, 2007, the content of which is hereby incorporated by reference into this application.

### BACKGROUND OF THE INVENTION

This invention relates to a system for predicting a free energy of a polymer by means of a simulation, which is applied to a drug design system and an analysis system for measuring an interaction between biopolymers, such as a molecular probe, a mass analysis, and a protein chip.

In the post-genome era, as drugs which promote or inhibit biological functions of the polymers, compound molecule structures have been developed for proteins, DNA's, and RNA's obtained from genome information. For example, a compound molecule structure is designed for a target protein by changing molecule species, reactive groups, and skeleton structures of the compound so as to reduce the free energy of the protein and the compound. The free energy is a sum of a binding energy of a complex produced by binding the protein and the compound, and an entropy energy which is obtained by subtracting the entropy energy of the protein and the entropy energy of the compound from the entropy energy of the complex.

A drug design system calculates a free energy for a large number of configuration structures of the protein and the compound. An optimum design for the compound molecule structure is carried out by searching for a binding structure which brings about the minimum free energy.

As the method for predicting a structure of a polymer, there is known a method which employs a homology modeling (such as a method disclosed in JP 2004-258814 A). Moreover, for the search for the binding structure, a free energy with respect to the same protein is calculated for different compounds repeatedly. Search methods employed for the nonlinear optimization problem are known (such as a method disclosed in JP 2003-248671 A).

### SUMMARY OF THE INVENTION

In a conventional system, for a polymer to be simulated such as a protein, a DNA, and an RNA obtained from genome information, since a user repeatedly calculates a free energy for different compounds in terms of the same protein by using a molecular dynamics method or the like, which poses a problem of a long calculation time.

Especially, for a search for a binding structure of a complex between the protein and a compound, it is necessary to carry out calculations in time steps for a long period of time for the complex between the protein and the compound in a solution, thereby sequentially selecting candidate binding structures, resulting in an enormous number of the candidate binding structures, which poses a problem that a long period of time is required for calculating the binding energy of the candidate binding structures. Especially, there has been a problem that a long period of time is required for calculating a binding energy of a protein in a solution with respect to a candidate binding structure. Moreover, there are an extremely large number of states for calculating the entropy energy of a candidate binding structure in the solution, resulting in an extremely long period of time required for the calculation.

It is therefore an object of this invention to provide a design system of binding energy for polymer molecule which can calculate fast and precisely the minimum value of the free energy which is the sum of the binding energy and the entropy energy.

This invention provides a design system of binding energy for polymer molecule, including a computer including a processor for carrying out a calculation process, a memory system for storing a program and data, an input system for inputting data on a complex constructed by a protein in a hydration state and a compound, a control unit for obtaining a minimum value of a free energy of the complex based on the input data, and an output system for outputting a result of the calculation carried out by the control unit. The control unit includes: an input unit for receiving, from the input system, a reference binding structure of the complex constructed by the protein in the hydration state and the compound, a search region for a candidate binding structure of the complex, the number of candidate binding structures for which a binding energy according to structure optimization is calculated, and the number of candidate binding structures for which an entropy energy is calculated according to normal frequency analysis; an unbound protein optimum structure setting unit for setting an optimum structure of an unbound protein in a solution; a candidate binding structure calculation unit for, by removing water molecules from the protein, and searching for a local minimum value in the binding energy in the search region, selecting N^{h} candidate binding structures between the protein and the compound; a structure optimization unit for adding the removed water molecules, carrying out structure optimization for the compound, protein, and complex in the solution, selecting N^{S} candidate binding structures, and carrying out, for the selected candidate binding structures, structure optimization for the protein and the compound in the solution; an entropy processing unit for calculating entropy, in the solution, of the candidate binding structures for which the structure optimization has been carried out; and a complex determination unit for determining a complex structure of a candidate binding structure having a minimum free energy, which is a sum of the binding energy and the entropy energy.

Further, the design system of binding energy for polymer molecule includes a second computer coupled to the computer via a network and including a processor for carrying out a calculation process, and a memory system for storing a program and data, the second computer carrying out an arithmetic operation according to an instruction issued by the computer. The candidate binding structure calculation unit includes: a water molecule removal unit for removing the water molecules surrounding the unbound protein and storing a water molecule structure in the hydration state; a search execution unit for setting a search region for the candidate binding structure between the unbound protein and the compound obtained by removing the water molecules, and the number of decomposed regions of the search region to determine the candidate binding structures with a local minimum binding energy; and a candidate selection unit for selecting N^{h} candidate binding structures, which are close in configuration structure of the compound with respect to the input reference binding structure of the complex, from the candidate binding structures determined by the search execution unit. The structure optimization unit includes: a water molecule adding unit for adding the water molecules removed by the water molecule removal unit to the candidate binding structures selected by the candidate selection unit, and removing water molecules adjacent to atoms of the compound; a binding energy calculation unit for, for the N^{h} candidate binding structures in the solution selected by the candidate selection unit, instructing the second computer to carry out the structure optimization for obtaining the optimum structures of the candidate binding structures, and the calculation of the binding energy, and receiving optimum structures of the complex of the candidate binding structures in the solution, and the binding energies, which are results of the calculation, from the second computer; an optimum structure selection unit for selecting N^{S} optimum structures of the candidate binding structures received from the second computer having the lowest binding energies; a compound structure setting unit for one of setting protein structures in the solution obtained by removing the compound from the N^{S} optimum structures of the candidate binding structures in the solution, and adding water molecules to and manipulating the protein structures, and setting compound structures in the solution obtained by removing the protein from the N^{S} optimum structures of the candidate binding structures in the solution, and adding water molecules to and manipulating the compound structures; and an optimum structure calculation unit for, for one of the protein structures in the solution of the N^{S} candidate binding structures in the solution, and the compound structures in the solution of the N^{S} candidate binding structures in the solution, instructing the second computer to carry out the calculation for the structure optimization, and receiving the optimum structures of the one of the protein and the compound of the candidate binding structures in the solution as a result of the calculation from the second computer. The entropy processing unit includes an entropy calculation execution unit for instructing the second computer to carry out calculation of the entropy energies according to the normal frequency analysis for the complex in the solution, and the one of the protein and the compound in the solution of the N^{S} candidate binding structures in the solution, and receiving the entropy of the complex, and the one of the protein and the compound of the candidate binding structures in the solution, which are calculation results from the second computer.

As described above, according to this invention, by carrying out only once the structure optimization for the unbound protein in the solution, it is possible to largely reduce the amount of calculation process compared with the comparative example in which the time step calculation is carried out for a complex between a protein and a compound in the solution.

Moreover, by calculating, after removing the water molecules surrounding the unbound protein, the local minimum values in the biding energy according to the region decomposition, it is possible to largely reduce the amount of calculation process required for obtaining candidate binding structures of the complex between the protein and the compound. As a result, it is possible to obtain the candidate binding structures of the complex at high speed.

Then, when the water molecules surrounding the unbound protein are removed, the water molecule structure in the hydration state is stored, and, after selecting the candidate binding structures of the complex, the removed water molecule structure is added to these candidates, and the water molecules adjacent to the compound atoms are removed. Therefore, it is possible to maintain the precision of the result of the calculation while the amount of calculation process is largely reduced for the structure optimization for the complex.

Further, in the structure optimization, the compound is removed from the optimum complex structures, and then, the optimum structures of the protein are obtained from the protein structures in the solution to which the water molecules are added and which are manipulated. Alternatively, the protein is removed from the optimum complex structures in the solution, and then, the optimum structures of the compound are obtained from the compound structures in the solution to which the water molecules are added and which are manipulated. As a result, it is possible to reduce the amount of calculation process for the structure optimization.

Then, for the calculation of the entropy for the candidate complex structures in the solution, by manipulating the water molecules, and setting the mass of the water molecules to the predetermined value, it is possible to largely reduce the normal frequency of the water molecules, and to largely reduce the amount of calculation process of the entropy. As a result, it is possible to carry out the calculation processing for the entropy at extremely high speed.

Moreover, a user of the system only need to enter the reference binding structure of the complex between the protein and the compound, the search region of the candidate binding candidates, the number of the candidate binding structures for which the binding energy is calculated according to the structure optimization, and the number of the candidate binding structures for which the entropy energy is calculated according to the specific frequency analysis.

The user of the system does not need to set load distribution for the binding energy calculation and the entropy energy calculation, and the setting is automatically carried out while the optimum number of the computing units is predicted. The minimum value of the free energy, which is the sum of the binding energy and the entropy energy, can be calculated at high speed.

### BRIEF DESCRIPTION OF THE DRAWINGS

FIG. 1 shows a first embodiment of this invention, and is a block diagram showing an example of a computer system according to this invention, which is a parallel and distributed computer system for predicting a free energy of a polymer by means of a simulation.

FIG. 2 shows a first embodiment of this invention, is a block diagram showing an example of a configuration of the PC cluster shown in FIG. 1.

FIG. 3 shows a first embodiment of this invention, is a block diagram showing an example of a configuration of the distributed shared cluster shown in FIG. 1.

FIG. 4 shows a first embodiment of this invention, is a block diagram showing a software configuration and a hardware configuration of a design system of binding energy for polymer molecule carried out on the parallel and distributed computer system.

FIG. 5 shows a first embodiment of this invention, is a schematic diagram showing contents of processes carried out by a design system of binding energy for polymer molecule, and shows an example in which a protein in the hydration state and a compound are entered, and an optimum binding structure of a complex between the protein and the compound is obtained.

FIG. 6 shows a first embodiment of this invention, shows the reference binding structure of a complex constructed by a protein 301 surrounded by water molecule solution.

FIG. 7 shows a first embodiment of this invention, describes a search region based on the translational operation in the space in which the protein is disposed.

FIG. 8A shows a first embodiment of this invention, shows a rotational operation applied to the compound by an Euler angle φ.

FIG. 8B shows a first embodiment of this invention, shows a rotational operation applied to the compound by an Euler angle θ.

FIG. 8C shows a first embodiment of this invention, shows a rotational operation applied to the compound by an Euler angle ψ.

FIG. 9 shows the first embodiment of this invention, is a chart showing a relationship between the binding energy and the coordinate in the two dimensional space of the decomposed translational search region or the decomposed rotational search region, and shows an example of the linear search in the gradient direction of the energy in the decomposed search regions in the two dimensional space of the translational search region or the rotational search region.

FIG. 10 shows a first embodiment of this invention, describes how the calculation process of the binding energy according to the structure optimization for the candidate binding structures in the solution is distributed to the respective computing units of the PC clusters coupled via a network.

FIG. 11 shows a first embodiment of this invention, describes how the calculation process for the structure optimization for the protein structures in the solution or the compound structures in the solution is distributed to the respective computing units of the PC clusters coupled via a network.

FIG. 12 shows a first embodiment of this invention, describes how the calculation process of the entropy energy for the optimum complex structures in the solution, the optimum protein structures in the solution or the optimum compound structures in the solution is distributed to the respective computing units of the highly-parallel computers on the distributed shared memory coupled via a network.

FIG. 13 shows a comparison between the number of calculations according to this invention and the number of calculations according to the comparative example described later for the macro processes A to D.

FIG. 14 shows a first embodiment of this invention, is a chart, in the design system of binding energy for polymer molecule according to the first embodiment of this invention, showing dependencies on atoms for calculation process times TnewA+B, TnewA+B+D, TnewA+B+C+D, TnewA+B+C′+D′, and Tnew employing the macro process steps A to D, where the number of atoms of the calculation process times is Nw′+Np.

FIG. 15 shows a first embodiment of this invention, is a chart showing a relationship, with the macro step processes as parameter, between the number of atoms and the calculation process time, and shows an effect brought about by the load dispersion for the calculation of the binding energy according to the structure optimization, and the calculation of the entropy energy according to the normal frequency analysis.

FIG. 16 shows a second embodiment of this invention, is dependency of the calculation process time Tnew employing the macro process steps A to D on the numbers N^{PC}_{PE} and N^{DSM}_{PE} of the computing units.

FIG. 17 shows a third embodiment of this invention, is, in the design system of binding energy for polymer molecule, another example of the dependency of the calculation process time Tnew employing the macro process steps A to D on the numbers N^{PC}_{PE} and N^{DSM}_{PE} of computing units.

FIG. 18 is a map showing the calculated values (predicted values) of the respective energies of the complex constructed by the protein and the compound according to the result of the calculations, and the measured values of the energies of the complex actually generated according to this invention.

FIG. 19 is a block diagram showing another example of the computer system.

FIG. 20 is a block diagram showing a software configuration and a hardware configuration of a design system of binding energy for polymer molecule as a comparative example with respect to this invention.

FIG. 21 is a conceptual diagram of the free energy G, which is the sum of the binding energy between protein atoms and compound atoms, and the entropy energies between protein atoms and compound atoms.

### DETAILED DESCRIPTION OF THE PREFERRED EMBODIMENTS

A description will now be given of embodiments of this invention with reference to accompanying drawings. It should be noted that like components are denoted by like numerals throughout the drawings for describing the embodiments, and will not be redundantly explained.

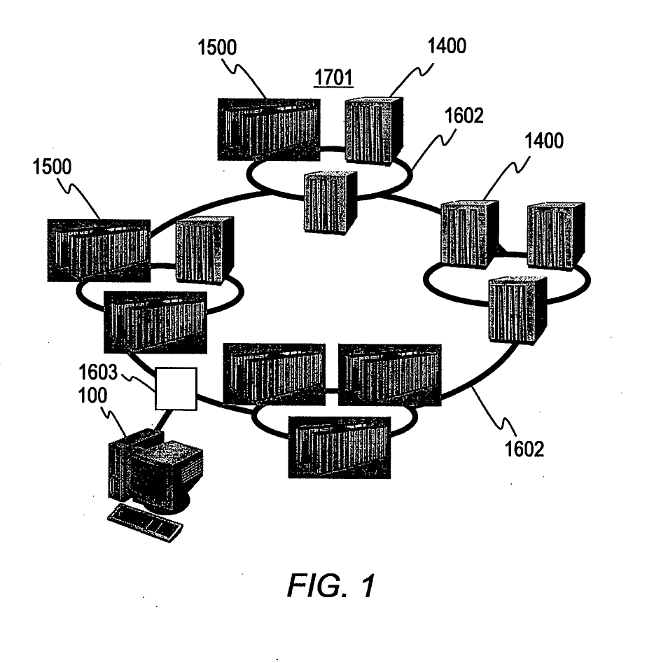

FIG. 1 is a block diagram showing an example of a computer system according to this invention, which is a parallel and distributed computer system for predicting a free energy of a polymer by means of a simulation.

In FIG. 1, the parallel and distributed computer system presents a wide area distributed environment which couples distributed shared clusters 1500 including a plurality of computing units (highly-parallel computers) configured as distributed shared memory systems, PC clusters 1400 including a plurality of personal computers, and a network 1602 coupling the distributed shared cluster 1500 and the PC cluster 1400, in a ring shape. To the network 1602, a management unit (management computer) 1603 which manages the parallel and distributed computer system is coupled. Then, via the management unit 1603, a personal computer 100, which instructs the plurality of clusters or computing units to carry out calculation, and receives results of the calculation, is coupled to the network 1602. It should be noted that the network 1602 may be constructed by the Internet or the like. Moreover, the distributed shared cluster 1500 and the PC cluster 1400 may constitute a cluster 1701, and may be coupled in a ring shape in the cluster 1701.

The personal computer 100 carries out processes such as input of data subject to the simulation, distribution of the calculation to the respective clusters or computing units, and collecting results of the calculation from the respective clusters or computing units.

The management unit 1603 collects information such as the number N_{PE} of the computing units of the PC clusters 1400 and the distributed shared clusters 1500 as the number of processors operable in the entire parallel and distributed computer system, processor types and processing performances of connectable computing units, and speed of the network 1602, and provides the personal computer 100 with the collected information.

Moreover, the personal computer 100 includes a processor for carrying out an arithmetic operation, a memory for storing data and programs, an input system 101 for inputting data, and setting calculation conditions and the like to be provided to the computing units of the respective clusters, and an output system 103 for displaying data and results of calculations. Moreover, the personal computer 100 includes a memory system for storing data and programs, and a graphical visualization system for generating images.

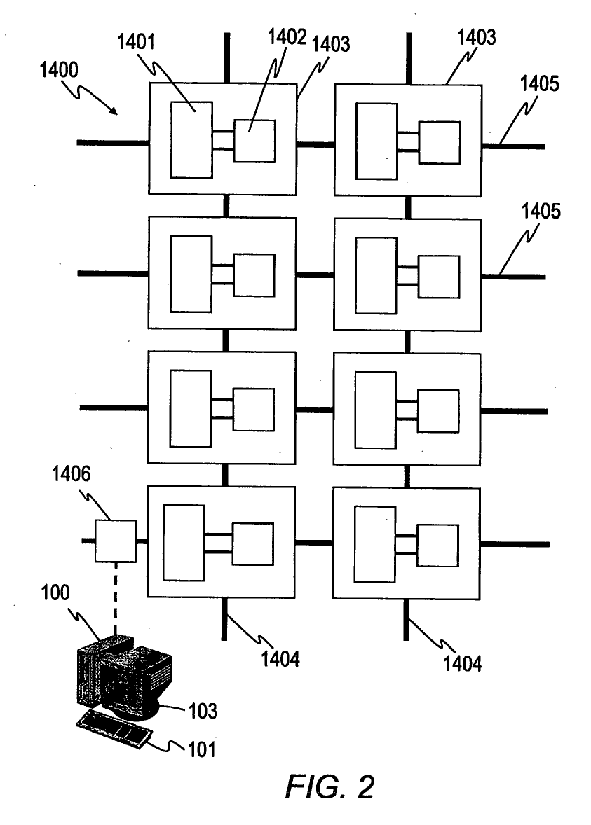

FIG. 2 is a block diagram showing an example of a configuration of the PC cluster 1400 shown in FIG. 1.

The PC cluster 1400 includes a plurality of computing units 1403 coupled to data transfer networks 1404 and 1405 configured into a grid, and a management unit 1406 provided at a connection point between the plurality of computing units 1403 and the data transfer networks 1404 and 1405 for managing the PC cluster 1400. The plurality of computing units 1403 are constructed by a personal computer. It should be noted that the management unit 1406 is managed by the management unit 1603 for managing the entire parallel and distributed computer system. Moreover, to the management unit 1406 of the PC cluster 1400, the personal computer 100 may be coupled.

The computing unit 1403, which is a unit of the calculation process, is constructed by a computing processing unit (processor) 1401 for carrying out the calculation process and a memory unit 1402 for storing input data required for carrying out the calculation process, and output data obtained by carrying out the calculation process. Moreover, the computing units 1403, which are the units of the calculation process, are coupled via the networks 1404 and 1405, which carry out the data transfer to and from other computing units 1403, into the grid.

On one of the networks 1404 and 1405 for data transfer, the personal computer 100 may be provided for control of the parallel and distributed computer system.

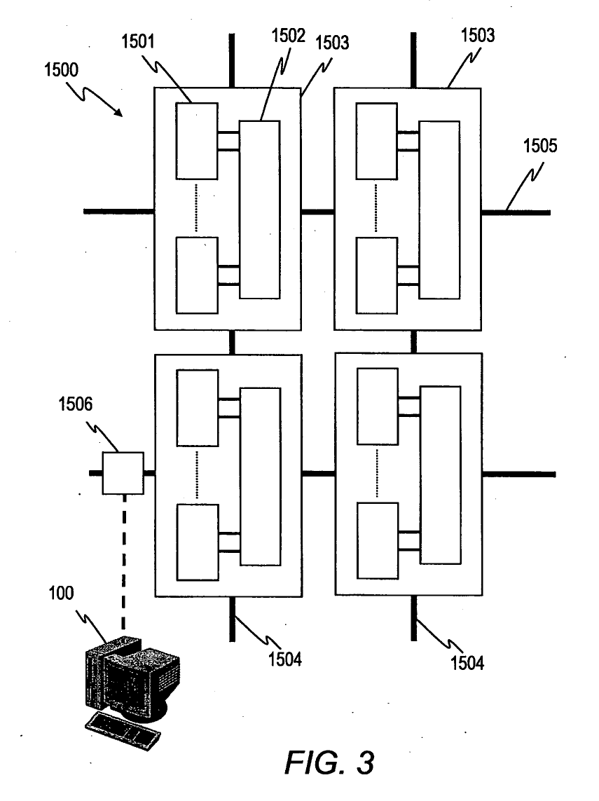

FIG. 3 is a block diagram showing an example of a configuration of the distributed shared cluster 1500 shown in FIG. 1.

In FIG. 3, a plurality of computing units 1503, which serve as units of a calculation process, are constructed by a plurality of computing processing units (processors) 1501 for carrying out the calculation process, and a single distributed shared memory unit 1502 for storing input data required for carrying out the calculation process, and output data obtained by carrying out the calculation process. The respective computing units (distributed shared nodes) 1503 are coupled with each other via networks 1504 and 1505 configured as a grid. To a predetermined position on the networks 1504 and 1505 in the grid configuration, a management unit 1506 for managing the computing units 1503 of the distributed shared cluster 1500 is coupled. It should be noted that, to the management unit 1506, the personal computer 100 shown in FIG. 1 may be coupled. It should be noted that the management unit 1506 is managed by the management unit 1603 for managing the entire parallel and distributed computer system.

The management unit 1506 collects information such as the number of the computing processing units 1501 of the distributed shared memory system as the number of processors operable in the distributed shared cluster 1500, the processor types and processing performances of connectable computing units 1503, and the speed of the networks 1504 and 1505, and provides the personal computer 100 with the collected information.

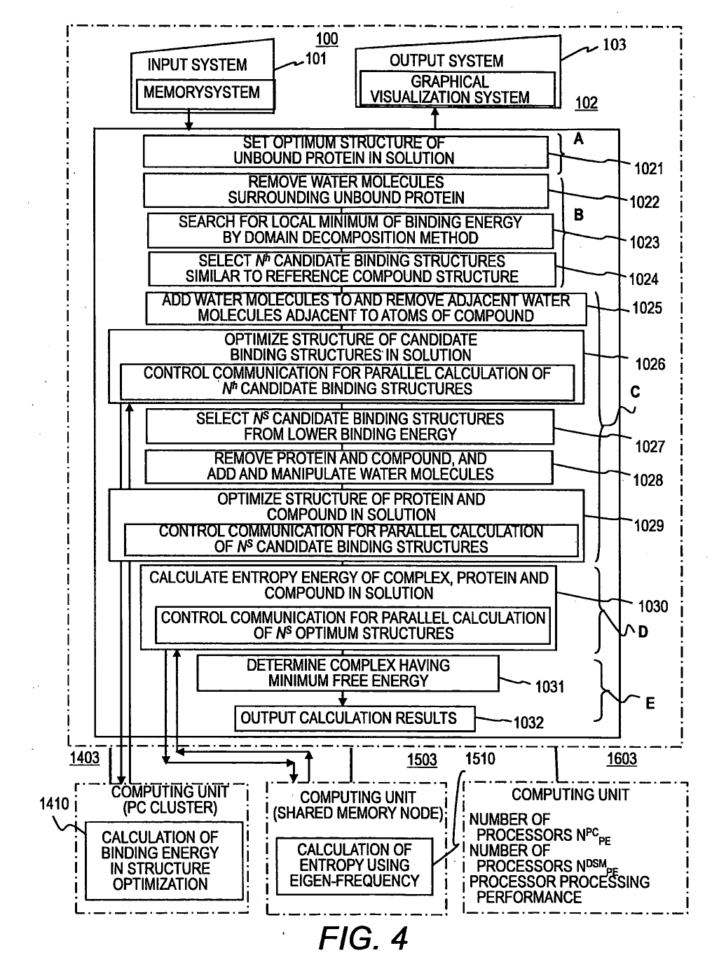

FIG. 4 is a block diagram showing a software configuration and a hardware configuration of a design system of binding energy for polymer molecule carried out on the parallel and distributed computer system. On the personal computer 100, a processing/control unit 102, which distributes the calculation process to the respective clusters or computing units, collects results of the calculation process from the respective clusters or computing units, and outputs a result of the simulation, is carried out. The processing/control unit 102 is constructed by a simulation management program, for example. The processing/control unit 102 is loaded on the memory system of the personal computer 100, and is carried out by the processor. It should be noted that a hardware configuration of the personal computer 100, as in the case of the computing unit 1403 of the PC cluster 1400 shown in FIG. 2, includes the processor 1401 for carrying out the calculation process, the memory unit 1402 for storing data and programs, an interface for carrying out communication with other computers, the input system 101, and the output system 103.

According to this embodiment, in the computing unit 1403 of the PC cluster 1400, a program 1410 for calculating binding energy according to structure optimization is executed, and in the computing unit 1503 of the distributed shared cluster 1500 of the parallel and distributed computer system, a program 1510 for calculating entropy according to normal frequency analysis is executed. In other words, the design system of binding energy for polymer molecule according to this invention is mainly constructed by the simulation management program of the personal computer 100, the program 1410 for calculating binding energy of the PC clusters 1400, and the program 1510 for calculating entropy of the distributed shared clusters 1500.

In FIG. 4, the processing/control unit 102 carries out a process of distributing the data used for the simulation, which is entered from the input system 101, to the respective computing units 1403, thereby causing the computing units 1403 to carry out the calculation process for the binding energy according to the structure optimization in the distributed manner. Moreover, the processing/control unit 102 carries out a process of integrating results of the calculation process for the binding energy according to the structure optimization carried out by the respective computing units 1403 based on the distributed data.

The processing/control unit 102 causes the output system 103 to display an operation state of the processing/control unit 102 and the integrated data.

Moreover, the processing/control unit 102 carries out a process of distributing the data, which is entered from the input system 101, to the respective computing units 1503, thereby causing the computing units 1503 to carry out the calculation process for the entropy energy according to the normal frequency analysis in the distributed manner. Moreover, the processing/control unit 102 carries out a process of integrating results of the calculation process for the entropy energy according to the normal frequency analysis carried out by the respective computing units 1503 based on the distributed data.

In FIG. 4, the personal computer 100 includes the memory system such as a disk or a memory for holding necessary programs and data, a graphical visualization system for generating display images for an interface with a user, and the like, and those memory system and graphical visualization system are shown in the blocks of the input system 101 and the output system 103 for convenience of illustration. It should be noted that the simulation management program and the program 1410 for calculating binding energy may be stored on a storage medium such as a disk device or a non-volatile memory.

The computing units 1403 and 1503 carry out calculation processes according to instructions from the personal computer 100, and transfers results of the calculation processes to the personal computer 100. Moreover, the management unit 1603 collects information from the management units of the respective clusters, and notifies the personal computer 100 of the collected information.

The personal computer 100, the computing units 1403 and 1503, and the management unit 1603 of the parallel and distributed computer system can mutually exchange necessary data, and are thus indicated by bold lines. Moreover, relations between process steps of the processing/control unit 102 and process steps of the computing units 1403 and 1503 are indicated by thin solid lines.

### (Overview of Processing)

A description will now be given of an overview of processing in the design system of binding energy for polymer molecule according to this invention.

A user of the personal computer 100 inputs, as a polymer to be simulated, such as a protein, a DNA, and an RNA obtained from genome information, from the input system 101, a reference binding structure of a complex constructed by a protein and a compound, a search region for candidate binding structures, the number of candidate binding structures for which the binding energy is calculated according to the structure optimization, the number of candidate binding structures for which the entropy energy is calculated according to the normal frequency analysis, and the number N_{PE} of the computing units available in the distributed shared clusters 1500 and the PC clusters 1400 of the distributed shared memory system in the parallel and distributed environment.

Then, the personal computer 100 causes the PC clusters 1400 and the distributed shared clusters 1500 to carry out the process of predicting free energy of the polymer with the following processing steps.
(1) The personal computer 100 sets an optimum structure of an unbound protein in a solution.
(2) The personal computer 100 removes water molecules surrounding the unbound protein and stores a water molecule structure in the hydration state.
(3) The personal computer 100 sets a search region for the binding structure between the unbound protein and the compound in the processing step (2), and the number of decomposed regions for decomposing the search region, and determines candidate binding structures having the local minimum binding energy.
(4) The personal computer 100 selects N^{h} candidate binding structures similar in configuration structure of the compound to the reference binding structure of the complex between the protein and the compound.
(5) The personal computer 100 adds the water molecules removed in the processing step (2) to the candidate binding structures and removes water molecules adjacent to atoms of the compound from the candidate binding structures.
(6) For the N^{h} candidate binding structures in the solution selected in the processing step (4), for carrying out the structure optimization and the parallel calculation of the binding energy, the personal computer 100 transmits the complex structures in the solution to the computing units 1403 of the PC clusters 1400 on the parallel and distributed computer system, thereby causing the computing units 1403 to calculate the optimum complex structures in the solution and the binding energies. Then, the personal computer 100, receives, from the computing units 1403, results of the calculation of the optimum complex structures in the solution and the binding energies.
(7) The personal computer 100 selects N^{S} optimum complex structures in the solution in order from the optimum complex structures having the lowest binding energies according to the received results.
(8) The personal computer 100 removes the compound from the N^{S} optimum complex structures in the solution, then adds and processes water molecules, and for protein structures in the solution, sets protein structures in the solution.

Alternatively, the personal computer 100 removes the protein from the N^{S} optimum complex structures in the solution, then adds and processes water molecules, and for compound structures in the solution, sets compound structures in the solution.
(9) For the N^{S} protein structures in the solution or the N^{S} compound structures in the solution, in order to carry out the parallel calculation for the structure optimization, the personal computer 100 transmits the protein structures in the solution or the compound structures in the solution to the computing units 1403 of the PC clusters 1400 on the parallel and distributed computer system, thereby causing the computing units 1403 to calculate the optimum protein structures in the solution or the optimum compound structures in the solution. Then, the personal computer 100 receives, from the computing units 1403, results of the calculation of the optimum protein structures in the solution or the optimum compound structures in the solution.
(10) For the N^{S} optimum complex structures in the solution, the N^{S} optimum protein structures in the solution, and the N^{S} optimum compound structures in the solution, in order to carry out the parallel calculation process of the entropy energy according to the normal frequency analysis, the personal computer 100 transmits the optimum complex structures in the solution, the optimum protein structures in the solution, and the optimum compound structures in the solution to the computing units 1503 of the distributed shared clusters 1500 on the parallel and distributed computer system, thereby instructing the computing units 1503 to calculate the entropy. Then, the personal computer 100 receives results of the calculation of the entropy energies of the optimum complex structures, the optimum protein structures, and the optimum compound structures from the computing units 1503.
(11) The personal computer 100 determines, based on free energies, which are respective sums of the N^{S} binding energies and N^{S} entropy energies, the minimum value of the free energies.

Moreover, the respective computing units of the parallel and distributed computer system:
(12) according to the processing steps (6) and (9) carried out by the personal computer 100, for the complex structure in the solution, the protein structure in the solution, and the compound structure in the solution, carry out the structure optimization and the calculation of the binding energy, and transmit the results to the personal computer 100; and
(13) according to the processing step (10) carried out by the personal computer 100, for the optimum complex structure in the solution, the optimum protein structure in the solution, and the optimum compound structure in the solution, calculate the entropy energy according to the normal frequency analysis, and transmit the results to the personal computer 100.

As a result of the above process, the output data of the respective computing units 1403, 1503 are the minimum free energy, the binding energy, and the entropy energy of the binding structure between the protein and the compound in the solution, and atomic coordinate data of the protein, the compound, and the water molecules in the binding structure, and the personal computer 100 outputs the output data as images or numerical data comprehensible to a user to the output system (display device) 103.

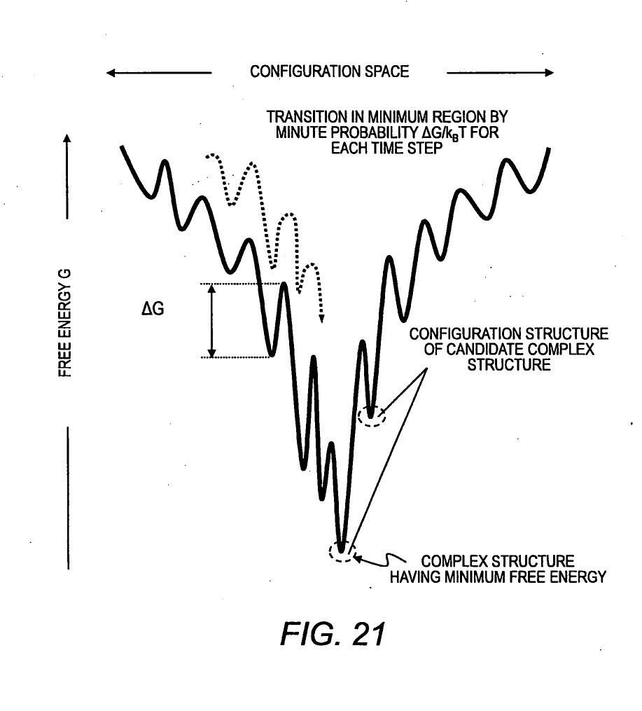

Referring to FIG. 21, a description will now be given of the processing steps (6) and (10) of calculating the binding energy and the entropy energy of the protein structures and the compound structures distributed to the respective computing units 1403 and 1503 according to a molecular dynamics method. FIG. 21 is a conceptual diagram of the free energy G, which is the sum of the binding energy between protein atoms and compound atoms, and the entropy energies between protein atoms and compound atoms. In terms of the free energy in the configuration space of the protein and the compound, for each time step set in advance, atoms are moved in the gradient direction of the free energy. On this occasion, when a difference in free energy between an original binding structure and a new binding structure is represented by ΔG, a probability P(ΔG) of a transition to the new binding structure is given by the following equation (1).

P(ΔG)=exp(−ΔG/+k_{B}T) (1)

where k_{B} is Boltzmann coefficient, and T is absolute temperature.

### (Details of Process)

In FIG. 4, the processing/control unit 102 of the personal computer 100 receives the data to be simulated via the input system 101, holds the data in the memory system, then, according to the processing steps (6), (9), and (10), distributes data, which is to be used for the calculation of the binding energy according to the structure optimization, to the computing units 1403 of the PC clusters 1400, and data, which is to be used for the calculation of the entropy energy according to the normal frequency analysis, to the computing units 1503 of the distributed shared clusters 1500, and then, instructs the execution of the calculation.

The respective computing units 1403 and 1503, based on the data distributed by the personal computer 100, integrate, in the processing step (11), the result of the calculation of the optimum binding structures and the binding energies carried out in the processing steps (6) and (9), and the result of the calculation of the entropy energies according to the normal frequency analysis in the processing step (10), and displays the result of the integration on the output system 103.

The output system 103 outputs the minimum free energy, the binding energy, and the entropy energy of the binding structure between the protein and the compound in the solution, and the atomic coordinate data of the protein, the compound, and the water molecules in the binding structure.

Moreover, for the processing/control unit 102 of the personal computer 100 as described above, one of the computing units 1403 or 1503 may be substituted, thereby distributing the calculation of the binding energies according to the structure optimization to the respective computing units 1403 of the PC clusters 1400, and the calculation of the entropy energies according to the normal frequency analysis to the respective computing units 1503 of the distributed shared clusters 1500, and integrating the results of the calculation of the binding energies and the entropy energies carried out by the respective computing units.

Referring to FIG. 4, a description will now be given of detailed processing steps of the calculation of the binding energies according to the structure optimization, and the integration of the results of the calculation, which are instructed by the processing/control unit 102 of the personal computer 100 to the respective computing units 1403 of the PC clusters 1400, and the calculation of the entropy energies according to the normal frequency analysis, and the integration of the results of the calculation, which are instructed by the processing/control unit 102 of the personal computer 100 to the respective computing units 1503 of the distributed shared clusters 1500.

In Step 1021, the personal computer 100, based on the reference binding structure of the complex constructed by the protein and the compound, calculates the optimum structure of the unbound protein in the solution, thereby setting the optimum structure of the unbound protein in the solution.

In Step 1022, the personal computer 100, for the optimum structure of the unbound protein in the solution, removes the water molecules surrounding the optimum structure of the unbound protein, and sets the unbound protein structure in the vacuum. Moreover, in Step 1022, the personal computer 100 stores the data on the structure of the water molecules in the hydration state surrounding the protein.

In Step 1023, the personal computer 100, as the search region for the binding structure between the unbound protein structure and the compound of the reference binding structure, sets a translational search region and a rotational search region, and sets the number of the decomposed regions for decomposing the search regions. In this step, in the respective decomposed regions, the candidate binding structure which has the local minimum binding energy between the protein and the compound is determined. It should be noted that the personal computer 100 causes the PC clusters 1400 or the distributed shared clusters 1500 to carry out the search in Step 1023.

In Step 1024, the personal computer 100 compares the compound structure in the reference binding structure, and the compound structure in the candidate binding structures, thereby selecting N^{h} candidate binding structures which have the similar mean square errors in atomic coordinate of the compound structure. The number N^{h} is the number of the candidate binding structures for which the binding energy is to be calculated according to the structure optimization.

In Step 1025, to the N^{h} candidate binding structures, the water molecule structure in the hydration state surrounding the protein stored in Step 1022 is added. Moreover, in this step, the water molecules adjacent to the atoms of the compound are removed from the candidate binding structures when the water molecule structure is added.

In Step 1026, for the N^{h} candidate binding structures in the solution produced in Step 1025, in order to carry out the parallel calculation process of the binding energy according to the structure optimization, the candidate binding structures in the solution are transmitted to the computing units 1403 of the PC clusters 1400 on the parallel and distributed computer system, and the execution of the calculation is instructed. When the calculation of the binding energy according to the structure optimization is finished, the PC clusters 1400 transmit the results of the calculation to the personal computer 100. The personal computer 100 receives the results of the calculation from the PC clusters 1400.

In Step 1026, before the transmission of the instruction of the calculation to the PC clusters 1400, based on the N^{h} candidate binding structures in the solution, and the number N_{PE} of the computing units available on the distributed shared clusters 1500 and the PC clusters 1400 in the parallel and distributed environment, the number N^{PC}_{PE} of the computing units 1403 of the PC clusters 1400 which calculate the binding energy according to the structure optimization is determined. Then, when the calculation is instructed to the PC clusters 1400, first, the personal computer 100 notifies the management unit 1603 of the determined number N^{PC}_{PE} of the computing units 1403, and transmits the data and the instruction to the management unit 1603. The management unit 1603 transfers, to the number N^{PC}_{PE} of the computing units 1403 requested by the personal computer 100, the data and the instruction, thereby causing the computing units 1403 to carry out the calculation. If the management unit 1603 cannot allocate the requested number N^{PC}_{PE} of the computing units 1403, the management unit 1603 may notify the personal computer 100 of an error. In this embodiment, when the personal computer 100, and the PC clusters 1400 or the distributed shared clusters 1500 communicate with each other, the communication is carried out via the management units 1603, 1406, and 1506.

In Step 1027, for the N^{h} candidate binding structures in the solution obtained in Step 1026, the N^{S} optimum complex structures in the solution in order from the optimum complex structures having the lowest binding energies are selected. The number N^{S} is the number of the candidate binding structures for which the entropy energy is to be calculated according to the normal frequency analysis.

In Step 1028, the protein structures in the solution are obtained by removing the compound structure from the N^{S} optimum complex structures in the solution selected in Step 1027, or the protein structures in the solution are obtained by adding the water molecules to a hollow generated by removing the compound structure from the N^{S} optimum complex structures in the solution. Moreover, the compound structures in the solution are obtained by removing the protein structure from the N^{S} optimum complex structures in the solution, or the compound structures in the solution are obtained by adding the water molecules to a hollow generated by removing the protein structure from the N^{S} optimum complex structures in the solution.

In Step 1029, for the N^{S} protein structures in the solution or the N^{S} compound structures in the solution selected in Step 1028, the PC clusters 1400 are caused to carry out the parallel calculation process for the structure optimization. The personal computer 100 transmits the protein structures in the solution or the compound structures in the solution to the computing units 1403 of the PC clusters 1400 on the parallel and distributed computer system, and instructs the computing units 1403 of the PC clusters 1400 to execute the calculation of the optimum structure. Then, when the calculation is finished in the PC clusters 1400, the personal computer 100 receives the optimum protein structures in the solution or the optimum compound structures in the solution from the computing units 1403.

Before instructing the PC clusters 1400 to execute the calculation, the personal computer 100, based on the number N^{S} of protein structures in the solution or the number N^{S} of compound structures in the solution, and the number N_{PE} of the computing units available on the distributed shared clusters 1500 and the PC clusters 1400 in the parallel and distributed environment, determines the number N^{PC}_{PE} of the computing units 1403 of the PC clusters 1400 which carries out the structure optimization, and notifies the management unit 1603 thereof.

In Step 1030, for the N^{S} complex structures in the solution, the N^{S} protein structures in the solution, and the N^{S} compound structures in the solution, the distributed shared memory system carries out the parallel calculation process of the entropy energy according to the normal frequency analysis. Thus, the personal computer 100 transmits, to the computing units 1503 of the distributed shared clusters 1500 on the parallel and distributed computer system, the optimum complex structures in the solution, the optimum protein structures in the solution, and the optimum compound structures in the solution, to thereby instruct the execution of the calculation. When the calculation is finished in the distributed shared clusters 1500, the personal computer 100 receives the entropy energies of the complex structures, the entropy energies of the protein structures, and the entropy energies of the compound structures from the computing units 1503.

In Step 1031, the personal computer 100 determines the minimum value of the free energies which are respectively the sum of the binding energy of the N^{S} complex structures and the entropy energy obtained by subtracting the entropy energy of the protein and the entropy energy of the compound from the entropy energy of the optimum complex structure, which are the results of the calculation.

In Step 1032, the minimum (local minimum) free energy, the binding energy, and the entropy energy of the binding structure between the protein and the compound in the solution, and the atomic coordinate data of the protein, the compound, and the water molecules in the binding structure are output to the output system 103.

As a result of the above process, the personal computer 100 once carries out the calculation for obtaining the optimum structure of the unbound protein in the solution. Then, on the respective computing units 1403 in the parallel and distributed computer system, the personal computer 100 receives the complex structures in the solution, the protein structures in the solution and the compound structures in the solution respectively obtained in Steps 1026 and 1029. Moreover, the PC clusters 1400 carry out the structure optimization based on the atomic coordinates of the protein, the compound, and the water molecules, and calculate the binding energy between the protein and the compound. The calculated optimum complex structures in the solution, the calculated optimum protein structures in the solution, the calculated optimum compound structures in the solution, and the binding energy of the complex are transmitted to the personal computer 100 in Steps 1026 and 1029, which carry out the communication control. The respective computing units 1503 of the distributed shared memory system on the parallel and distributed computer system receive, in Step 1030, the calculated optimum complex structures in the solution, the calculated optimum protein structures in the solution, and the calculated optimum compound structure in the solution from the personal computer 100. The respective computing units 1503, based on the atomic coordinates of the protein, the compound, and the water molecules, carry out the normal frequency analysis, thereby calculating the entropy energy of the complex, the entropy energy of the protein, and the entropy energy of the compound. The calculated entropy energy of the complex, the calculated entropy energy of the protein, and the calculated entropy energy of the compound are transmitted to the personal computer 100 in Step 1030, which carries out the communication control. In the personal computer 100, the minimum (local minimum) free energy, the binding energy, and the entropy energy of the binding structure between the protein and the compound in the solution, and the atomic coordinate data of the protein, the compound, and the water molecules in the binding structure are obtained, thereby obtaining the optimum binding structure of the protein and the compound. In other words, the complex structure with the minimum free energy shown in FIG. 21 can be obtained fast.

On this occasion, the process from Steps 1021 to 1032 can be divided into five macro process steps A to E shown in FIG. 4.

A. Process of inputting the protein in the hydration state and the compound, and setting the optimum structure for the unbound protein in the solution (step 1021)

B. Process of removing the water molecules from the protein, searching for the local minimum of the binding energy, and selecting N^{h} candidate binding structures of the protein and the compound (Steps 1022 to 1024)

C. Process of adding the water molecules again, carrying out the structure optimization for the complex, the compound and the protein in the solution, calculating the binding energy, and selecting N^{S} candidate binding structures (Steps 1025 to 1029)

D. Process of calculating the entropy in the solution (Step 1030)

E. Process of determining the complex structure with the minimum free energy (Steps 1031, 1032)

For Step 1023 in the process B, Japanese Patent Application No. 2006-040685 (P2007-219913A, US 2007-260795) proposed by the applicant of this application may be employed for the search for the local minimum value of the binding energy according to the region decomposition.

This is realized by causing the personal computer 100 to carry out the following process.

(a) In terms of the free energy and the configuration space shown in FIG. 21, determining a decomposition width used to decompose the search region for the polymer, and the number of searches to be carried out in the decomposed regions, which decompose the search region.

(b) Determining the number of the decomposed regions which can decompose the search region.

(c) Determining the number of the computing units 1403 (or the processors 1501) of the PC clusters 1400 (or the distributed shared clusters 1500) to which the decomposed regions are assigned.

(d) Assigning the decomposed regions to the respective computing units 1403 (or the processors 1501).

(e) Determining search points in the respective decomposed regions.

(f) Transmitting data on the search points to the computing unit 1403 (or 1503), and instructing execution of calculation of a binding energy and an energy gradient vector. Receiving, upon completion of the calculation on the computing unit 1403 (or the processors 1501), results of the calculation.

(g) Determining, based on the received results of the calculation, the local minimum value of the binding energy in the decomposed regions, and the minimum value of the search region.

(h) Determining convergence of the binding energy.

Moreover, the computing units 1403 (1503) of the PC clusters 1400 (or the distributed shared clusters 1500) carry out the following process.

(i) Calculating, based on the data on the search point, the binding energy and the energy gradient vector.

(j) Transmitting the binding energy and the energy gradient vector, which are the result of the calculation, to the personal computer 100.

As a result of the above process, it is possible to obtain the local minimum values in the binding energy between the protein in the state with the water molecules removed and the compound, and to obtain a plurality of candidate binding structures with the local minimum binding energy.

### First Embodiment

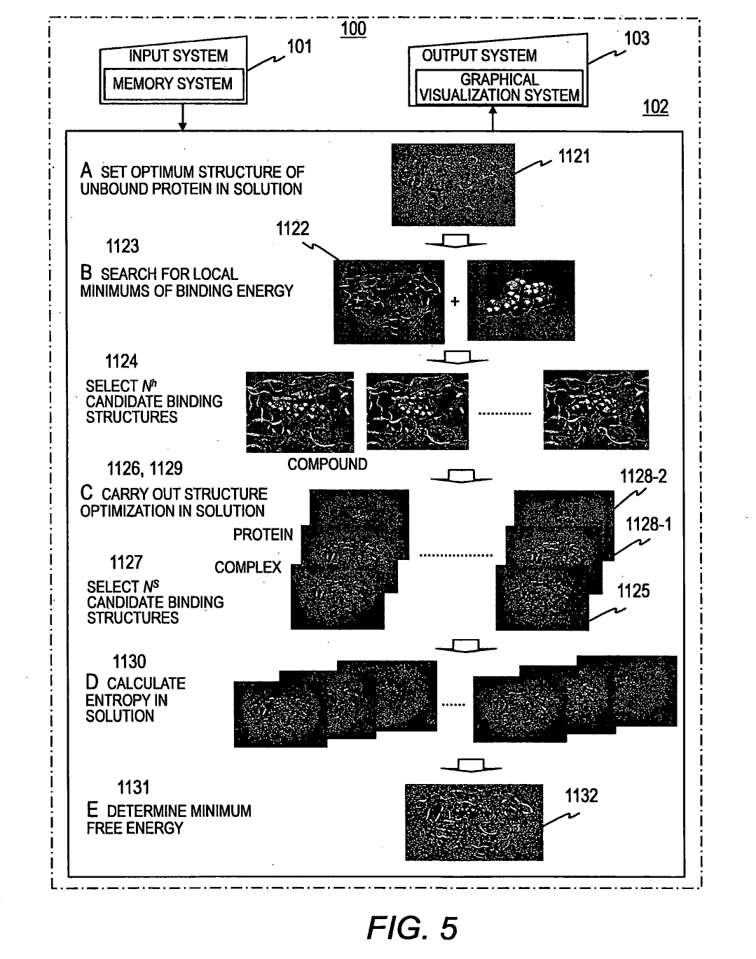

FIG. 5 shows a first embodiment of this invention, is a schematic diagram showing contents of processes carried out by a design system of binding energy for polymer molecule, and shows an example in which a protein in the hydration state and a compound are entered, and an optimum binding structure of a complex between the protein and the compound is obtained.

A detailed description will be given of the processes according to this embodiment, which is similar to the five processes shown in FIG. 4.

A. Process of entering the protein in the hydration state and the compound, and setting the optimum structure of the unbound protein in the solution

B. Process of searching for the candidate binding structures with local minimum binding energy by means of translational operations and rotational operations of the configuration space of the protein and the compound

C. Process of parallel calculation of the binding energy of the candidate binding structures in the solution according to the structure optimization

D. Process of parallel calculation of the entropy energies of the complex, the protein, and the compound in the solution according to the normal frequency analysis

E. Process of calculating the minimum value of the free energy

The overall configuration is similar to contents of the processes shown in FIG. 4, but the processing/control unit 102 shown in FIG. 4 and the respective process steps 1021 to 1032 are changed to a processing/control unit 112, and the respective processing steps 1121 to 1132 according to changes in contents of the processes. The micro process steps A to E shown in FIG. 5 correspond to the process steps A to E shown in FIG. 4.

A user enters, for a polymer to be simulated such as a protein, a DNA, and an RNA obtained from genome information, from the input system 101, a reference binding structure of a complex constructed by a protein and a compound, a search region for candidate binding structures, the number of candidate binding structures for which the binding energy is calculated according to the structure optimization, the number of candidate binding structures for which the entropy energy is calculated according to the normal frequency analysis, and the number of processors 1501 available in the distributed shared clusters 1500 and the number of computing units 1403 available in the PC clusters 1400 in the parallel and distributed environment.

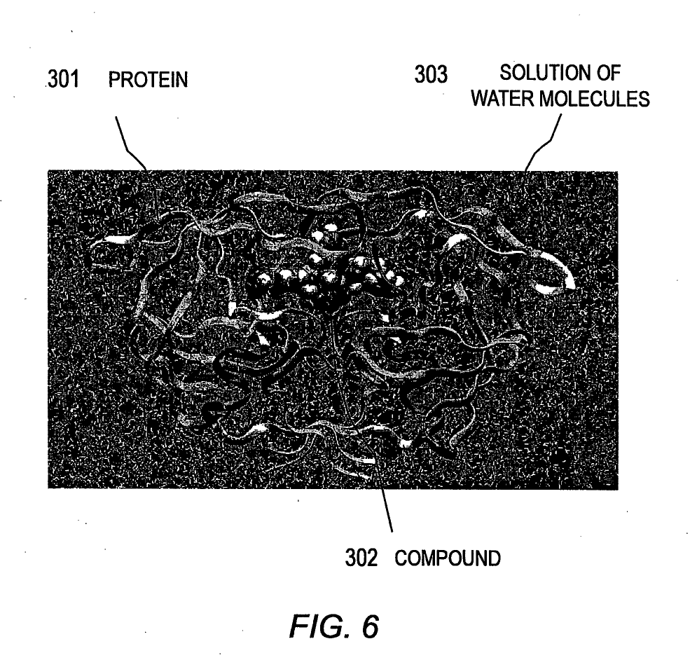

FIG. 6 shows the reference binding structure of a complex constructed by a protein 301 surrounded by water molecule solution 303, and a compound 302 bound to a pocket region present at the center of the protein 301, which is analyzed by a measuring device using the X ray or the nuclear magnetic resonance (NMR). In the process A, the reference binding structure of the complex constructed by the protein and the compound shown in FIG. 6 is entered to the personal computer 100.

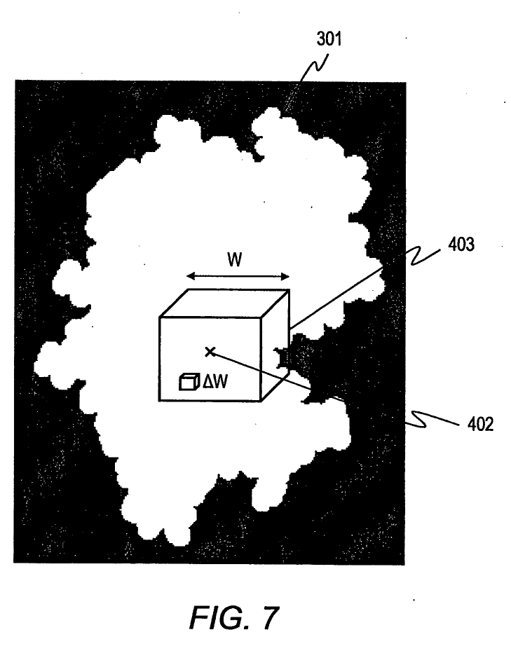

FIG. 7 describes a search region based on the translational operation in the space in which the protein is disposed. In the protein 301, as the search region based on the translational operation, a space in a cubic shape is specified by entering a coordinate of a center position 402 and a space region width W 403. On this occasion, a smaller cube with a decomposition width ΔW schematically shows a decomposed region in the translational search region represented as the cubic search region with the width W 403.

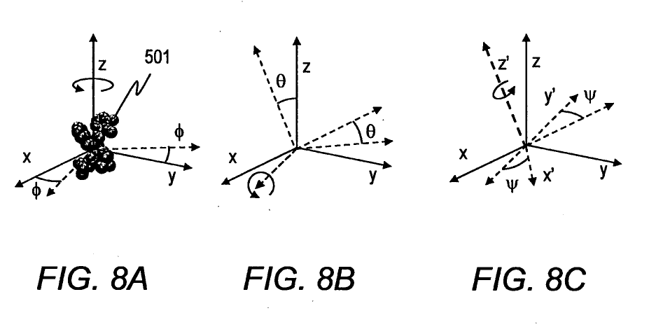

FIGS. 8A to 8C are charts showing examples of the rotational search region in which a compound 501 is rotated according to the Euler angles: φ, θ, and ψ. FIG. 8A shows a rotational operation applied to the compound by an Euler angle φ, FIG. 8B shows a rotational operation applied to the compound by an Euler angle θ, and FIG. 8C shows a rotational operation applied to the compound by an Euler angle ψ.

As the number of the candidate binding structures, in Step 1024, the number N^{h} is set for the candidate binding structures for which the binding energy is calculated according to the structure optimization, and, in Step 1027, the number N^{S} is set for the candidate binding structures for which the entropy energy is calculated according to the normal frequency analysis.

Moreover, in Step 1026, the number N^{PC}_{PE} of the computing units 1403 available in the PC clusters 1400 in the parallel and distributed environment, and the number N^{DSM}_{PE} of the processors 1501 available in the distributed shared clusters 1500 of the distributed shared memories in the parallel and distributed environment are entered. The numbers N^{PC}_{PE} and N^{DSM}_{PE} of the available computing units may be entered by the user, or may be provided by the management unit 1603 of the parallel and distributed computer system.

In FIG. 5, in Step 1121 in the macro process A, as in Step 1021 of FIG. 4, based on the reference binding structure of the complex constructed by the protein and the complex, the optimum structure is calculated for the unbound protein in the solution. Based on the reference structure of the complex, the water molecules are arranged around the protein structure and the protein thereof. The structure optimization for the unbound protein in the solution is carried out by calculating interaction energies between atoms, and moving the atomic coordinate in the energy gradient direction or conjugate gradient direction. Iteration of the structure optimization is carried out, and a structure in which the movements in atomic coordinate have been sufficiently converged is set to the optimum structure of the unbound protein in the solution.

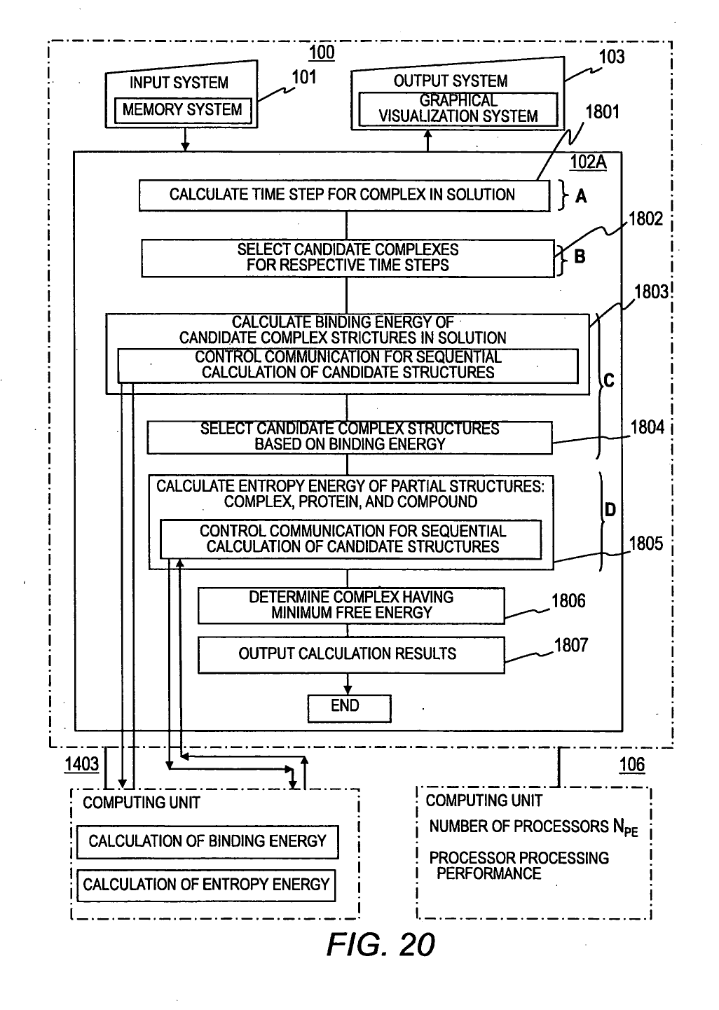

FIG. 20 is a block diagram showing a software configuration and a hardware configuration of a design system of binding energy for polymer molecule as a comparative example with respect to this invention.

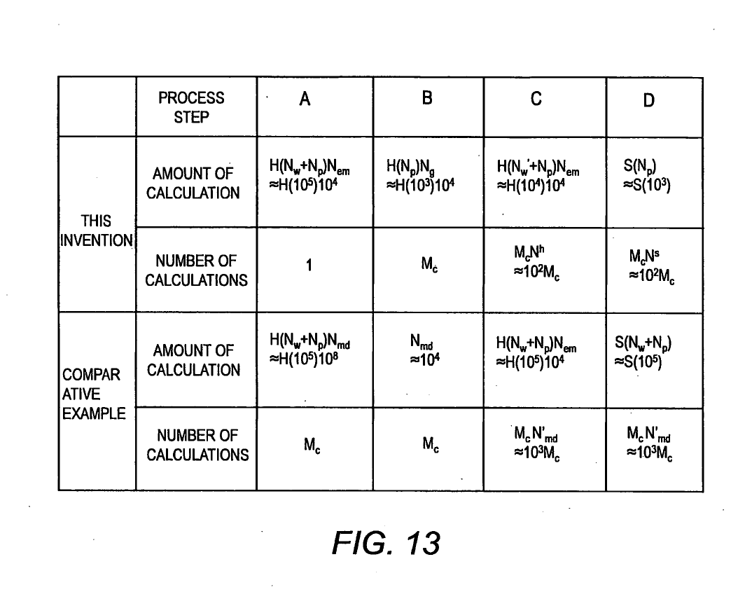

As shown in FIG. 20, it is known that, since the energy gradient between the atoms is calculated, the amount of calculation (number of operations) for one step in the structure optimization is proportional to H(N)=N log 2N, where N denotes the number of the atoms. When the number of the water molecules is Nw, and the number of the atoms of the unbound protein is Np, the number of atoms of the unbound protein in the solution is Nw+Np. When the number of steps of the structure optimization is Nem, the amount of calculation H for the macro process A is represented as H(Nw+Np)Nem. According to this invention, the number of executions of the structure optimization is not dependent on the number of compounds, and is only one. It should be noted that, FIG. 13 shows a comparison between the number of calculations according to this invention and the number of calculations according to the comparative example described later for the macro processes A to D.

As a result of the process A, in the optimum structure of the unbound protein in the solution, the optimized water molecule structure surrounds the unbound protein in the hydration state.

In Step 1122 of the macro step B, based on the result of the process A, the water molecules surrounding the unbound protein are removed, thereby setting the unbound protein structure in the vacuum. Moreover, in order to use in Step 1125 described later, the optimized surrounding water molecule structure in the hydration state is stored in the memory system of the personal computer 100 or the like.

In Step 1123 of the macro process B, as the search regions for the binding structure between the unbound protein structure from which the water molecules are removed, which is set in Step 1122, and the compound structure in the entered reference binding structure, the translational search region shown in FIG. 7 and the rotational search region shown in FIGS. 8A to 8C are set. The number of decomposed regions decomposing the translational search region, and the number of decomposed regions decomposing the rotational search region may be set as in Japanese Patent Application No. 2006-040685 proposed by the applicant of this application.

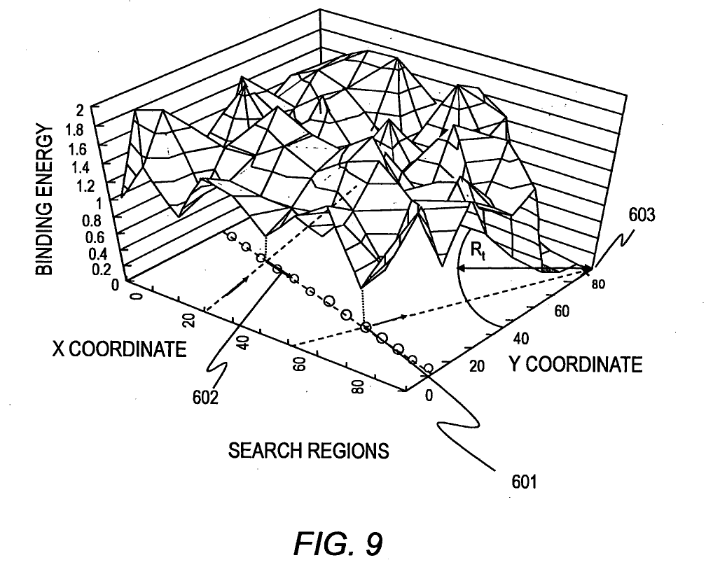

FIG. 9 shows the first embodiment of this invention, is a chart showing a relationship between the binding energy and the coordinate in the two dimensional space of the decomposed translational search region or the decomposed rotational search region, and shows an example of the linear search in the gradient direction of the energy in the decomposed search regions in the two dimensional space of the translational search region or the rotational search region. As shown in FIG. 9, the binding energy of the binding structure between the protein and the compound presents an undulating geometry including ridges and valleys in the respective decomposed regions. According to the number of the decomposed regions decomposing the translational search region, it is possible to determine a decomposition width of the translational search region, and the number of linear searches 601 in an energy gradient direction 602. A binding energy of the binding structure corresponding to a linear search point in the translational decomposition region is obtained, and a binding structure having a local minimum value 603 in the binding energy is determined as a candidate binding structure. Moreover, according to the number of the decomposed regions decomposing the rotational search region, it is possible to determine a decomposition width of the rotational search region, and the number of linear searches in a torque direction of the energy gradient. A binding energy of the binding structure corresponding to a linear search point in the rotational decomposition region is obtained, and a binding structure having a local minimum in the binding energy is determined as a candidate binding structure.

As shown in FIG. 20, since the energy gradient between atoms is calculated for one linear search, the amount of calculation is represented as H(N). The amount of calculation in the macro process step B is represented as H(Np+Nc)Ng, where Np denotes the number of atoms of the unbound protein, NC denotes the number of atoms of the compound, and Ng denotes the number of search points in the linear search 601. Since a relationship Np>>Nc holds generally, the amount of calculation is represented as H(Np)Ng. Then, the number of calculations for searching for the candidate binding structures is once for one compound, and when the number of the compounds is Mc, the number of calculations is represented as Mc.

In Step 1124 of the macro process step B, when the protein structure is fitted such that the mean square error between the coordinates of the protein atoms of the reference binding structure of the complex and the coordinates of the protein atoms of the candidate binding structure is minimum, the mean square error between the coordinates of the compound atoms of the reference binding structure of the complex and the coordinates of the compound atoms of the candidate binding structure is calculated.

Of the candidate binding structures, N^{h} candidate binding structures having the minimum mean square errors in the atomic coordinate of the compound structure are selected. On this occasion, as described later, N^{h} is the number of candidate binding structures for which the binding energy is calculated according to the structure optimization in Step 1126.

In Step 1125 of the macro process step C, the water molecule structure in the hydration state stored in Step 1122 is added to the N^{h} candidate binding structures. Of the water molecule structures, only Nw′ of water molecules existing in a predetermined probe radius rp from the center of the protein atoms are selected and added to the candidate binding structure. The water molecule structure is optimized in the hydration state for unbound protein, and, thus, does not come in contact with the protein atoms, but may come in contact with the compound atoms.

The water molecules adjacent to the compound atoms exert an abnormal force field on the compound atoms, and are thus removed. For example, if the interaction energy between a compound atom and an adjacent water molecule is 1×10⁴ kcal/mol, the adjacent water molecule is removed. In other words, if the interaction energy between a compound atom and an adjacent water molecule exceeds the threshold energy, the adjacent water molecule is removed.

In Step 1126 of the macro process step C, for the N^{h} candidate binding structures in the solution produced in Step 1125, in order to carry out the parallel calculation process of the binding energy for the structure optimization, the communication in which the candidate binding structures in the solution are transmitted to the computing units 1403 (or 1503) on the parallel and distributed computer system, and the optimum complex structures in the solution and the binding energies are received from the computing units used for the parallel computing is controlled. As shown in FIG. 20, the amount of the calculation for one step in the structure optimization for the candidate binding structure in the solution is proportional to H(N), where N denotes the number of atoms, since the energy gradient between the atoms is calculated. The amount of the calculation is represented as H(Nw′+Np+Nc)Nem, where Nw′ denotes the number of the added surrounding water molecules, Np denotes the number of atoms of the protein, Nc denotes the number of atoms of the compound, and Nem denotes the number of steps for the structure optimization. Since a relationship Nw′, Np>>Nc holds generally, the amount of calculation is represented as H(Nw′+Np)Nem. Then, for the N^{h} candidate binding structures in the solution, the structure optimization is carried out for the respective compounds and the respective binding structures, and, thus, the number of calculations for the structure optimization is represented as Mc×N^{h}, where Mc denotes the number of the compounds.

On this occasion, based on the N^{h} candidate binding structures in the solution and the number N^{PC}_{PE} of the computing units 1403 available on the PC clusters 1400 in the parallel and distributed environment, the number of candidate binding structures for which the binding energy according to the structure optimization is calculated on the respective computing units 1403 is determined.

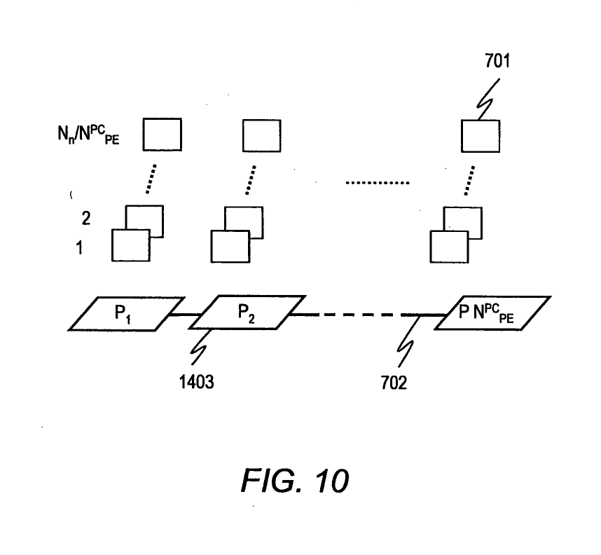

FIG. 10 describes how the calculation process of the binding energy according to the structure optimization for the candidate binding structures in the solution is distributed to the respective computing units 1403 of the PC clusters 1400 coupled via a network. As shown in FIG. 10, in order to equalize a load imposed by the calculation, the N^{h} candidate biding structures 701 in the solution are equally distributed to the N^{PC}_{PE} computing units 1403 coupled via the Internet or a high-speed network 702. As a result, the personal computer 100 distributes N^{h}/N^{PC}_{PE} candidate binding structures 701 in the solution to the respective computing units 1403 for the respective compounds.

In Step 1127 of the macro process step C, since the binding energies have been obtained for the N^{h} optimum complex structures in the solution in Step 1126, the N^{S} optimum complex structures in the solution in order from the optimum complex structures having the lowest binding energies are selected. On this occasion, as described later, N^{S} is the number of candidate binding structures for which the entropy energy is calculated according to the normal frequency analysis in Step 1130.

In Step 1128-1 of the macro process step C, from the N^{S} optimum complex structures in the solution, the protein structures in the solution are produced by removing the compound structure from the optimum complex structure in the solution. Alternatively, the protein structures in the solution are produced by adding the water molecules to the hollow generated by removing the compound structure from the N^{S} optimum complex structures in the solution.

In Step 1129 of the macro process step C, for the N^{S} protein structures in the solution produced in Step 1128-1, in order to carry out the parallel calculation for the structure optimization, the protein structures in the solution are transmitted to the computing units 1503 on the parallel and distributed computer system, and the computing units 1503 are caused to carry out the parallel calculation. When the calculation is finished on the computing units 1503, the personal computer 100 receives the optimum protein structures in the solution from the respective computing units 1503.

The amount of the calculation for one step in the structure optimization for the protein structure in the solution is proportional to H(N), where N denotes the number of atoms, because the energy gradient between the atoms is calculated. The amount of the calculation is represented by H(Nw′+Np)Nem, where Nw′ denotes the number of the added surrounding water molecules, Np denotes the number of atoms of the unbound protein, and Nem denotes the number of steps for the structure optimization. For the N^{S} protein structures in the solution, the structure optimization is carried out for the respective compound structures and the binding structures, and the number of the structure optimizations to be carried out is Mc×N^{S}, where Mc denotes the number of the compounds.

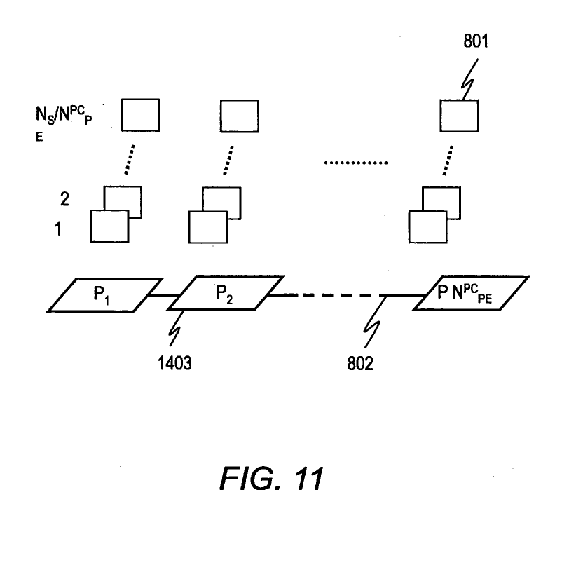

On this occasion, based on the N^{S} protein structures in the solution and the number N^{PC}_{PE} of the computing units 1403 available on the PC clusters 1400 in the parallel and distributed environment, the number of structure optimizations to be carried out on the respective computing units 1403 is determined. As shown in FIG. 11, in order to equalize a load imposed by the calculation, the N^{S} protein structures 801 in the solution are equally distributed to the N^{PC}_{PE} computing units 1403 coupled via the Internet or a high-speed network 802. As a result, the personal computer 100 distributes N^{S}/N^{PC}_{PE} protein structures 801 in the solution to the respective computing units 1403 for the respective compounds.

Further, in Step 1128-2 of the macro process step C, from the N^{S} optimum complex structures in the solution, the compound structures in the solution are produced by removing the protein structure from the optimum complex structure in the solution. Alternatively, the compound structures in the solution are produced by adding the water molecules to the hollow generated by removing the protein structure from the N^{S} optimum complex structures in the solution.

In Step 1129 of the macro process step C, for the N^{S} compound structures in the solution produced in Step 1128-2, in order to carry out the parallel calculation for the structure optimization, the compound structures in the solution are transmitted to the computing units 1403 (or 1503) on the parallel and distributed computer system, and the computing units 1403 (or 1503) are caused to calculate the optimum compound structure in the solution. When the calculation on the PC clusters 1400 or the distributed shared clusters 1500 is finished, the personal computer 100 controls the communication for receiving the optimum compound structures in the solution from the PC clusters 1400 or the distributed shared clusters 1500.

The amount of calculation for one step in the structure optimization for the compound structure in the solution is represented by H(Nw′+Nc)Nem, where Nw′ denotes the number of added surrounding water molecules, Nc denotes the number of atoms of the compound, and Nem denotes the number of steps for the structure optimization. Since a relationship Nw′>>Nc holds generally, the amount of calculation is represented by H(Nw′)Nem. For the N^{S} compound structures in the solution, the number of the structure optimizations to be carried out is Mc×N^{S}, where Mc denotes the number of the compounds.

On this occasion, based on the N^{S} compound structures in the solution and the number N^{PC}_{PE} of the computing units 1403 available on the PC clusters 1400 in the parallel and distributed environment, the number of structure optimizations to be carried out on the respective computing units 1403 is determined. FIG. 11 describes how the calculation process for the structure optimization for the protein structures in the solution or the compound structures in the solution is distributed to the respective computing units 1403 of the PC clusters 1400 coupled via a network. As shown in FIG. 11, in order to equalize a load imposed by the calculation process, the N^{S} compound structures 801 in the solution are equally distributed to the N^{PC}_{PE} computing units 1403 coupled via the Internet or the high-speed network 802. As a result, for the respective compounds, N^{S}/N^{PC}_{PE} compound structures in the solution are distributed to the respective computing units 1403.

In Step 1130 of the macro process step D, for the N^{S} optimum complex structures in the solution obtained in Step 1026, in order to carry out the parallel calculation process of the entropy energy according to the normal frequency analysis, the optimum complex structures in the solution are transmitted to the computing units 1503 of the distributed shared clusters 1500 on the parallel and distributed computer system, thereby causing the computing units 1503 to carry out the parallel calculation process. The personal computer 100 receives the entropy energies of the optimum complex structures from the computing units 1503 which have finished the calculation process.

As shown in FIG. 20, the amount of calculation S(N) for the normal frequency analysis for the optimum complex structures in the solution is proportional to N², where N denotes the number of atoms. The amount of calculation is represented by S(Nw′+Np+Nc), where Nw′ denotes the number of the added surrounding water molecules, Np denotes the number of atoms of the unbound protein, and Nc denotes the number of atoms of the compound. For the calculation process of the entropy of the complex in the solution, it is necessary to remove the entropy of the water molecules. In order to remove the degrees of freedom of the water molecules, while applying the force fields of the water molecules, by sufficiently increasing the mass of the water molecule by 10⁶ times of the original mass, for example, it is possible to make frequencies close to zero. Thus, the frequencies close to zero include three translational frequencies, three rotational frequencies, and 3Nw′ frequencies deriving from the water molecules. It is not necessary to obtain normal frequencies for those close to zero, and thus, the 3Nw′+6 smallest normal frequencies are removed from the subject normal frequency analysis, resulting in an amount of calculation S(Np+Nc). Since the relationship Np>>Nc holds generally, the amount of calculation is represented by S(Np). The number of executions of the normal frequency analysis is N^{S} for the respective compounds, and the number thereof is thus represented by Mc×N^{S}, where Mc denotes the number of the compounds.

On this occasion, based on the N^{S} optimum complex structures in the solution and the number N^{DSM}_{PE} of the processors 1501 available on the distributed shared clusters 1500 in the parallel and distributed environment, the number of entropy energies to be calculated according to the normal frequency analysis on the respective computing units 1503 is determined.

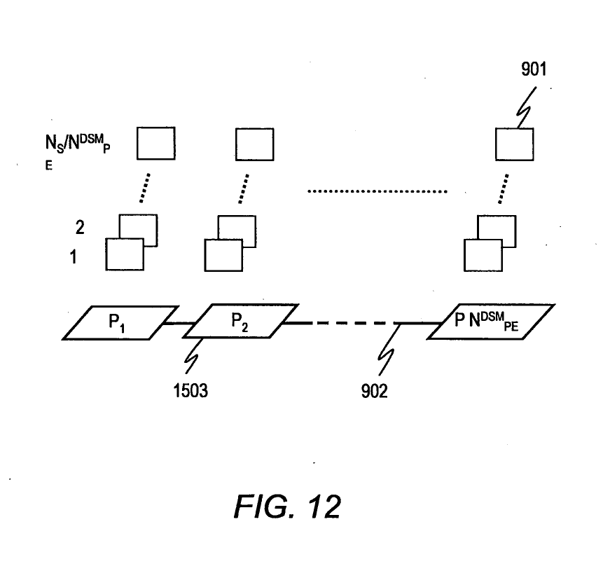

FIG. 12 describes how the calculation process of the entropy energy for the optimum complex structures in the solution, the optimum protein structures in the solution or the optimum compound structures in the solution is distributed to the respective computing units 1503 of the highly-parallel computers on the distributed shared memory coupled via a network. As shown in FIG. 12, in order to equalize a load imposed by the calculation process, the N^{S} optimum complex structures 901 in the solution are equally distributed to the N^{DSM}_{PE} processors 1501 in the computing units 1503 coupled via the Internet or a high-speed network 902. As a result, for the respective compounds, N^{S}/N^{DSM}_{PE} optimum complex structures in the solution are distributed to the respective computing units 1403.

In Step 1130 of the macro process step D, for the N^{S} optimum protein structures in the solution obtained in Step 1029, in order to carry out the parallel calculation process of the entropy energy according to the normal frequency analysis, the optimum protein structures in the solution are transmitted to the computing units 1503 of the distributed shared clusters 1500 on the parallel and distributed computer system, thereby causing the computing units 1503 to carry out the parallel calculation process of the entropy energies of the protein structures. When the calculation process is finished on the respective computing units 1503, the personal computer 100 receives the entropy energies of the optimum protein structures from the respective computing units 1503.

On this occasion, the amount of calculation is represented by S(Nw′+Np), where Nw′ denotes the number of the added surrounding water molecules, and Np denotes the number of atoms of the protein. Upon calculation of the entropy energy of the protein in the solution, it is necessary to remove the entropy of the water molecules, and thus, by sufficiently increasing the mass of the water molecule by 10⁶ times of the original mass, for example, it is possible to make the frequencies close to zero. Thus, it is not necessary to obtain the entropy for the 3Nw′+6 smallest normal frequencies, resulting in the amount of calculation S(Np). For the N^{S} optimum protein structures in the solution, the normal frequency analysis is carried out once for the respective compound structures, and thus, the number of the normal frequency analyses to be carried out is Mc×N^{S}, where Mc denotes the number of the compounds.

On this occasion, based on the N^{S} optimum protein structures in the solution and the number N^{DSM}_{PE} of the processors 1501 in the computing units 1503 available on the highly-parallel computers on the distributed shared memory in the parallel and distributed environment, the number of entropy energies to be calculated according to the normal frequency analysis on the respective computing units 1503 is determined. As shown in FIG. 12, in order to equalize a load imposed by the calculation process, the N^{S} optimum protein structures 901 in the solution are equally distributed to the N^{DSM}_{PE} processors 1501 in the computing units 1503 coupled via the Internet or the high-speed network 902. As a result, for the respective compounds, the personal computer 100 distributes N^{S}/N^{DSM}_{PE} optimum protein structures in the solution to the respective computing units 1503.

In Step 1130 of the macro process step D, for the N^{S} optimum compound structures in the solution obtained in Step 1029, in order to carry out the parallel calculation process of the entropy energy according to the normal frequency analysis, the optimum compound structures in the solution are transmitted to the computing units 1503 of the distributed shared clusters 1500 on the parallel and distributed computer system, thereby causing the computing units 1503 to carry out the parallel calculation process of the entropy energies of the compound structures. After the calculation process is completed, the personal computer 100 receives the entropy energies of the optimum compound structures from the respective computing units 1503.

On this occasion, the amount of the calculation is represented by S(Nw′+Nc), where Nw′ denotes the number of the added surrounding water molecules, and NC denotes the number of atoms of the compound. Upon calculation of the entropy of the compound in the solution, it is necessary to remove the entropy of the water molecules, and thus, by sufficiently increasing the mass of the water molecule by 10⁶ times of the original mass, for example, it is possible to make the frequencies close to zero. Thus, it is not necessary to obtain the entropy for the 3Nw′+6 smallest normal frequencies, resulting in the amount of calculation S(Nc). For the N^{S} optimum compound structures in the solution, the normal frequency analysis is carried out once for the respective compound structures, and thus, the number of the executions of the normal frequency analysis to be carried out is Mc×N^{S}, where Mc denotes the number of the compounds.

On this occasion, based on the N^{S} optimum compound structures in the solution and the number N^{DSM}_{PE} of the computing units available on the highly-parallel computers and the PC clusters 1400 in the parallel and distributed environment, the number of entropy energies to be calculated according to the normal frequency analysis on the respective computing units 1503 is determined. As shown in FIG. 12, in order to equalize a load imposed by the calculation process, the N^{S} optimum compound structures 901 in the solution are equally distributed to the N^{DSM}_{PE} processors 1501 in the computing units 1503 coupled via the Internet or the high-speed network 902. As a result, for the respective compounds, N^{S}/N^{DSM}_{PE} optimum compound structures in the solution are distributed to the respective computing units 1503.

In Step 1131 of the macro process step E, the binding energies have been obtained for the N^{S} optimum complex structures in Step 1127. Moreover, the entropy energies of the N^{S} optimum complex structures, the entropy energies of the N^{S} optimum protein structures, and the entropy energies of the N^{S} optimum compound structures have been obtained, and N^{S} entropy energies are obtained by respectively subtracting the entropy energy of the optimum protein structure and the entropy energy of the optimum compound structure from the entropy energy of the optimum complex structure. As a result, N^{S} free energies, each of which is the sum of the binding energy and the entropy energy are obtained, and thus, it is possible to determine the minimum value of those free energies.

In Step 1132, the minimum free energy, the binding energy, and the entropy energy of the binding structure between the protein and the compound in the solution, and the atomic coordinate data of the protein, the compound, and the water molecules in the binding structure are output.

Then, the respective computing units 1403 on the parallel and distributed computer system receive the complex structures in the solution, the protein structures in the solution, and the compound structures in the solution obtained in Steps 1126 and 1129. Based on the atomic coordinates of the protein structure, the atomic coordinates of the compound structure, and the atomic coordinates of the water molecules, the structure optimization is carried out, thereby calculating the binding energy between the protein and the compound. The calculated optimum complex structures in the solution, the calculated optimum protein structures in the solution, the calculated optimum compound structures in the solution, and the binding energy of the optimum complex structures are transmitted to the personal computer 100 in Steps 1126 and 1129, in which the communication control is carried out.

The respective computing units 1503 on the parallel and distributed computer system, in Step 1130, receive the optimum complex structures in the solution, the optimum protein structures in the solution, and the optimum compound structures in the solution. Based on the atomic coordinates of the protein structure, the atomic coordinates of the compound structure, and the atomic coordinates of the water molecules, the normal frequency analysis is carried out, thereby calculating the entropy energies of the complex, the entropy energies of the protein, and the entropy energies of the compound. The calculated entropy energy of the complex, the calculated entropy energy of the protein, and the calculated entropy energy of the compound are transmitted to the personal computer 100 in Step 1130, in which the communication control is carried out.

### COMPARATIVE EXAMPLE

In order to compare the amount of calculation according to this invention and the amount of the calculation according to the conventional technology, the comparative example is shown in FIG. 20. This comparative example is carried out by a control unit 102A of the personal computer 100, and the parallel calculation is carried out by the computing units 1403 of the PC clusters 1400.

FIG. 20 shows a concept of the comparative example which is a combination of a conventional example in which the simulation in which the free energy of a polymer is predicted on the parallel and distributed computer system as in the first embodiment, and the technology disclosed in Japanese Patent Application No. 2006-040685 proposed by the applicant.

In Step 1801, according to the molecular dynamics method or the like, a time step calculation is carried out for the complex constructed by the protein and the compound in the solution.

In Step 1802, for each time step, candidate complex structures leading to the next process step is selected. In Step 1803, in order to calculate the binding energy of the candidate complex structures in the solution, the personal computer 100 transmits the candidate complex structures in the solution to the computing units 1403 (or 1503) on the computer system, thereby causing the computing units 1403 (or 1503) to calculate the binding energy of the candidate complex structures in the solution and receiving the result of the calculation.

In Step 1804, based on the binding energy of the candidate complex structures-in the solution obtained in Step 1803, candidate complex structures leading to the next process step are selected.

In Step 1805, based on the candidate complex structures in the solution, in order to calculate the entropy energy of the candidate complex structures, the candidate protein structures, or the candidate compound structures in the solution, which are partial structures, the personal computer 100 transmits the candidate complex structures, the candidate protein structures, and the candidate compound structures in the solution to the computing units 1403 on the parallel and distributed computer system, and causes the computing units 1403 to calculate, in parallel, the entropy energies of the complex structures, the entropy energies of the protein structures, and the entropy energies of the compound structures. When the calculation is finished in the respective computing units 1403, the personal computer 100 receives the results of the calculation.

In Step 1806, for the free energies obtained by adding the binding energy of the complex to the entropy energy obtaining by subtracting the entropy energy of the protein and the entropy energy of the compound from the entropy energy of the complex, the minimum value thereof is determined.

In Step 1807, the minimum free energy, the binding energy, and the entropy energy of the binding structure between the protein and the compound in the solution, and the atomic coordinate data of the protein, the compound, and the water molecules in the binding structure are output.

The respective computing units 1403 on the parallel and distributed computer system receive the complex structures, the protein structures, and the compound structures in the solution in Step 1803. Then, the respective computing units 1403, based on the atomic coordinates of the protein, the compound, and the water molecules, calculate the binding energy between the protein and the compound. The calculated binding energies of the complex in the solution are transmitted in Step 1803, in which the communication control is carried out, to the personal computer 100.

Moreover, the respective computing units 1403 on the parallel and distributed computer system, in Step 1805, receive the complex structures, the protein structures, and the compound structures in the solution. Then, the respective computing units 1403, based on the atomic coordinates of the protein, the compound, and the water molecules, calculate the entropy energy of the complex, the entropy energy of the protein, and the entropy energy of the compound. The calculated entropy energy of the complex, the calculated entropy energy of the protein, and the calculated entropy energy of the compound are transmitted to the personal computer 100 in Step 1805, in which the communication control is carried out.

In the comparative example, as a result of the above process, it is possible to obtain the complex structure with the minimum free energy. The respective steps of this comparative example correspond to the macro process steps A to D according to the first embodiment as follows.

Macro process step A: Step 1801

Macro process step B: Step 1802

Macro process step C: Steps 1803 and 1804

Macro process step D: Step 1805

### Comparison in Amount of Calculation

A description will now be given of the comparison in the amount of calculation process between the first embodiment and the comparative example.

FIG. 13 shows the comparison in the amount of calculation process between the first embodiment of this invention and the comparative example for the respective macro process steps A to D.

A description will now be given of the amounts of calculation process in the macro process steps A to E according to the first embodiment. In the comparative example, as shown in FIG. 13, a sequential calculation is carried out, and the amount of calculation process therein is given by the following equation.

Tcov=Mc×[(Nmd/Nem+Nmd′)×H(Nw+Np)Nem+Nmd+Nmd′×S(Nw+Np)] (2)

In the macro process step A, the amount of calculation process according to the comparative example is represented by Mc×Nmd/Nem×H(Nw+Np)Nem, while the amount of calculation process according to the first embodiment is represented by H(Nw+Np)Nem, because Mc=1 and Nmd/Nem>=1.

In the macro process step B, the amount of calculation process according to the comparative example is represented by Mc×Nmd, while the amount of calculation process according to the first embodiment is represented by Mc×H(Np)Ng. Thus, the amount of calculation process in the macro process step B according to the first embodiment is sufficiently small compared with the amount of calculation process Mc×Nmd′×H(Nw′+Np)Nem for the complex structures in the solution in the macro process step C of the comparative example. Thus, the amount of calculation process in the macro process step B can be neglected.

Thus, the amount of calculation process Tnew(A+B) according to the first embodiment is represented by the following equation.

Tnew(A+B)=Mc×[Nmd′×H(Nw′+Np)Nem+Nmd′×S(Nw′+Np)] (3)

In the macro process step D, when the mass of the water molecules is sufficiently increased compared with the original mass, it is not necessary to obtain the entropy energies for 3Nw′+6 water molecules from the smallest normal frequencies, and hence, the amount of calculation process Tnew(A+B+D) according to the first embodiment is reduced as follows.

Tnew(A+B+D)=Mc×[Nmd′×H(Nw′+Np)Nem+Nmd′×S(Np)] (4)

In the macro process step C, N^{h} candidate binding structures in the solution are selected, and the binding energies are calculated according to the structure optimization. Moreover, in the macro process step C, N^{S} candidate binding structures in the solution are selected, and the entropy energies are calculated according to the normal frequency analysis. Thus, the amount of calculation process Tnew (A+B+C+D) according to the first embodiment is represented as follows.

Tnew(A+B+C+D)=Mc×[N^{h}×H(Nw′+Np)Nem+N^{S}×S(Np)] (5)

When N^{h}/N^{PC}_{PE} candidate binding structures in the solution are distributed to the respective computing units 1403, the amount of calculation process for the complex structures in the solution on the respective computing units 1403 in the macro process step C is represented by McN^{h}/N^{PC}_{PE}×H(Nw′+Np)Nem.

When N^{S}/N^{DSM}_{PE} candidate binding structures in the solution are distributed to the respective computing units 1503, the amount of calculation process for the complex structures in the solution on the respective computing units 1503 in the macro process step C is represented by McN^{S}/N^{DSM}_{PE}×S(Np), and the amount of calculation process Tnew(A+B+C′+D′) according to the first embodiment, which carries out the parallel and distributed processing, is given by the following equation.

Tnew(A+B+C′+D′)=Mc×[N^{h}/N^{PC}_{PE}×H(Nw′+Np)Nem+N^{S}/N^{DSM}_{PE}×S(Np)] (6)

Similarly, the amount of calculation process for the protein structures in the solution on the respective computing units 1403 in the macro process step C is represented by McN^{S}/N^{PC}_{PE}×H(Nw′+Np)Nem.

Moreover, the amount of calculation process for the compound structures in the solution on the respective computing units 1403 in the macro process step C is represented by McN^{S}/N^{PC}_{PE}×H(Nw)Nem.

As a result, the maximum amount of calculation process of the respective computing units 1403 in the macro process step C according to the first embodiment is represented by McN^{h}/N^{PC}_{PE}×H(Nw′+Np)Nem.

For the protein structures in the solution in the macro process step D, the amount of calculation process of the respective computing units 1503 is represented by McN^{S}/N^{DSM}_{PE}×S(Np).

For the compound structures in the solution in the macro process step D, the amount of calculation process of the respective computing units 1503 is represented by McN^{S}/N^{DSM}_{PE}×S(Nc).

As a result, the maximum amount of calculation process of the respective computing units 1503 in the macro process step D is represented by McN^{S}/N^{DSM}_{PE}×S(Np).

It is possible to simultaneously carry out the calculation of the binding energies according to the structure optimization for the protein structures in the solution in the macro process step C and the calculation of the entropy energies according to the normal frequency analysis for the optimum complex structures in the solution in the macro process step D, and thus, the load can be dispersed. Thus, on the respective computing units, the total amount of calculation process Tnew in the macro process steps A to D according to the first embodiment is given by the following equation.

Tnew=Mc×max[N^{h}/N^{PC}_{PE}×H(Nw′+Np)Nem, N^{S}/N^{DSM}_{PE}×S(Np)] (7)

In other words, the greater one of N^{h}/N^{PC}_{PE}×H(Nw+Np)Nem and N^{S}/N^{DSM}_{PE}×S(Np) is the maximum amount of calculation process according to the first embodiment.

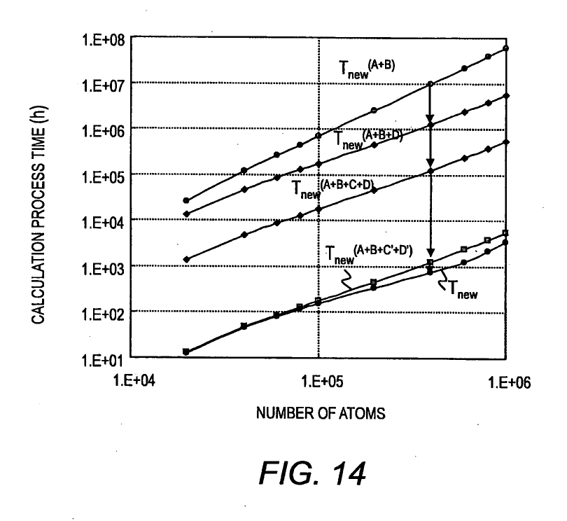

FIG. 14 is a chart, in the design system of binding energy for polymer molecule according to the first embodiment of this invention, showing dependencies on atoms for calculation process times TnewA+B, TnewA+B+D, TnewA+B+C+D, TnewA+B+C′+D′, and Tnew employing the macro process steps A to D, where the number of atoms of the calculation process times is Nw′+Np. The calculation process time Tnew shown in FIG. 14 is obtained by converting the amount of calculation process Tnew given by the equations (2) to (7) into a period of time required in the case in which the calculations are carried out in the parallel and distributed environment shown in FIGS. 1 to 3.

The example shown in FIG. 14 shows results obtained in the case in which the number Mc of the compounds is 1, the number Nw′+Np of atoms is 2×10⁴, a relationship Np=Nw′/3 holds, the number Nmd′ of time steps is 10³, the number N^{h} of calculated binding energies according to the structure optimization is 100, and the number N^{S} of calculated entropy energies according to the normal frequency analysis is 100. Moreover, the numbers N^{PC}_{PE} and N^{DSM}_{PE} of the available computing units are larger than the number N^{h} of candidate binding structures for which the binding energy is calculated according to the structure optimization, and the number N^{S} of candidate binding structures for which the entropy energy is calculated according to the normal frequency analysis, and N^{PC}_{PE} and N^{DSM}_{PE} are respectively N^{h} and N^{S}.

In FIG. 14, with respect to the calculation process time TnewA+B, the calculation process time TnewA+B+D can increase the speed by 1.9 to 10.9 times, with respect to the calculation process time TnewA+B+D, the calculation process time TnewA+B+C+D can increase the speed by 10 times, with respect to the calculation process time TnewA+B+C+D, the calculation process time TnewA+B+C′+D′ can increase the speed by 100 times, with respect to the calculation process time TnewA+B+C′+D′, the calculation process time Tnew can increase the speed by 1.1 to 2 times, and finally, with respect to the calculation process time TnewA+B, the calculation process time Tnew can increase the speed by 2024 to 17862 times.

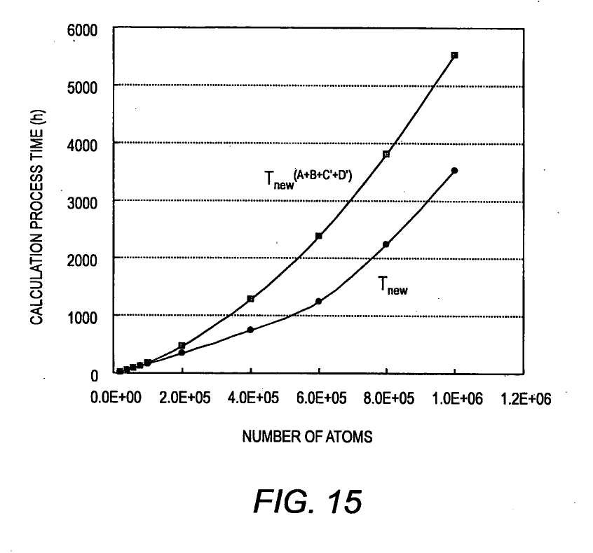

FIG. 15 is a chart showing a relationship, with the macro step processes as parameter, between the number of atoms and the calculation process time, and shows an effect brought about by the load dispersion for the calculation of the binding energy according to the structure optimization, and the calculation of the entropy energy according to the normal frequency analysis. FIG. 15 is an enlarged view in which the calculation process times TnewA+B+C′+D′ and Tnew are compared when the load dispersion is carried out for the calculation of the binding energy according to the structure optimization, and the calculation of the entropy energy according to the normal frequency analysis. As shown in FIG. 15, the calculation process time Tnew according to this invention shows that the calculation process time largely decreases.

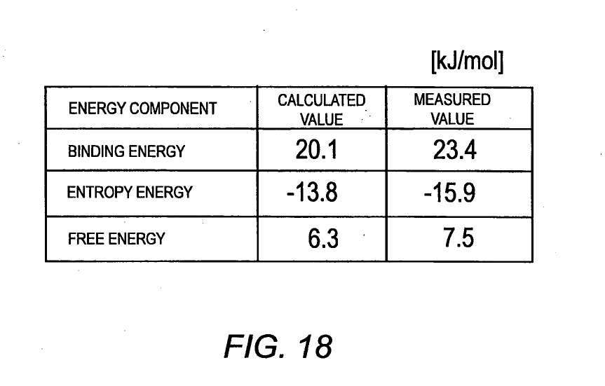

Then, FIG. 18 shows the calculated values (predicted values) of the respective energies of the complex constructed by the protein and the compound according to the result of the above calculations, and the measured values of the energies of the complex actually generated, which shows that the increase in calculation speed and the secured calculation precision are attained at the same time. It should be noted that FIG. 18 is a map showing the calculated values (predicted values) of the respective energies of the complex constructed by the protein and the compound according to the result of the calculations, and the measured values of the energies of the complex actually generated according to this invention.

### (Summary)

As described above, according to this invention, by carrying out only once the structure optimization for the unbound protein in the solution, it is possible to largely reduce the amount of calculation process compared with the comparative example in which the time step calculation is carried out for a complex constructed by a protein and a compound in the solution.

Moreover, by calculating, after removing the water molecules surrounding the unbound protein, the local minimum value in the binding energy by means of the region decomposition method, it is possible to largely reduce the amount of calculation process required for obtaining candidate binding structures of the complex constructed by the protein and the compound. As a result, it is possible to obtain the candidate binding structures of the complex at high speed.

Then, by, when the water molecules surrounding the unbound protein are removed, storing the water molecule structure in the hydration state, adding, after selecting the candidate binding structures of the complex, the removed water molecule structure to those candidate binding structures, and removing the water molecules adjacent to the compound atoms, it is possible to maintain the precision of the result of the calculation while the amount of the calculation process is largely reduced for the structure optimization for the complex.

Further, in the structure optimization, the compound is removed from the optimum complex structures, and then, the optimum protein structures are obtained from the protein structures in the solution to which the water molecules are added and manipulated. Alternatively, the protein is removed from the optimum complex structures in the solution, and then, the optimum compound structures are obtained from the compound structures in the solution to which the water molecules are added and manipulated. As a result, it is possible to reduce the amount of the calculation process for the structure optimization.

Then, for the calculation of the entropy for the candidate complex in the solution, by manipulating the water molecules, and setting the mass of the water molecules to the predetermined value, it is possible to largely reduce the normal frequency of the water molecules, and to largely reduce the amount of calculation process of the entropy. As a result, it is possible to carry out the calculation process for the entropy at extremely high speed.

Further, by carrying out the structure optimization and the calculation of the entropy as the parallel and distributed processing, it is possible to further increase the speed of the calculation process.

### Second Embodiment

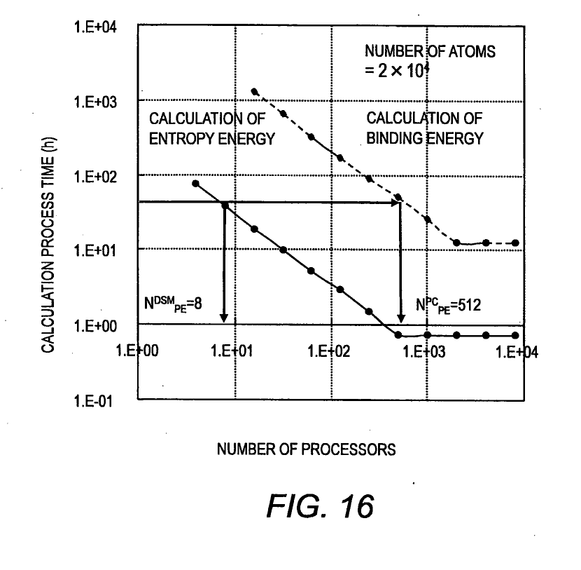

A description will now be given of a second embodiment of this invention shown in FIG. 16 in which a relationship between the number of processors and the calculation process time is shown with the content of the calculation process as parameter, and the number of atoms is 2×10⁴. FIG. 16 shows dependency of the calculation process time Tnew employing the macro process steps A to D on the numbers N^{PC}_{PE} and N^{DSM}_{PE} of the computing units.

In the example shown in FIG. 16, the number Mc of the compounds is 1, the number Nw′+Np of atoms is 2×10⁴, the relationship Np=Nw′/3 holds, the number N^{h} of calculated binding energies according to the structure optimization is 100, and the number N^{S} of calculated entropy energies according to the normal frequency analysis is 100. It should be noted that, as shown in the first embodiment, the case in which the binding energies are calculated by the PC clusters 1400, and the entropy is calculated by the distributed shared clusters 1500 is shown.

The process time N^{h}/N^{PC}_{PE}×H(Nw′+Np)Nem for calculating the binding energy according to the structure optimization is indicated by a broken line, and the process time N^{S}/N^{DSM}_{PE}×S(Np) for calculating the entropy energy according to the normal frequency analysis is indicated by a solid line. In order to equally disperse the load by means of the parallel processing, when, as the number of the computing units, the number N^{PC}_{PE} of the computing units 1403 of the PC clusters 1400 is 512, and the number N^{DSM}_{PE} of the computing units 1503 of the distributed shared clusters 1500 is 8, the equalized calculation process time can be approximately 80 hours.

In other words, by obtaining, in advance, the calculation process time corresponding to the type and number of the computing units shown in FIG. 16 based on an experiment or the like, and storing the calculation process time as a map or a table in the memory system of the personal computer 100, or the like, it is possible to determine the number of processors or the calculation process time based on any one of a desired calculation process time, or the number of the computing units of the PC clusters 1400 or the distributed shared clusters 1500.

According to the first embodiment, though the number N^{PC}_{PE} of the PC clusters 1400 (number of processors) and the number N^{DSM}_{PE} of processors of the computing units 1503 of the distributed shared clusters 1500 are provided as an input, it is difficult for an operator to properly set the number of the different types of computing units.

Therefore, by setting the calculation process time in terms of the type and number of the computing units for the respective types of calculation, it is easily set the conditions for the process of predicting the energy of the polymer.

For example, when the calculation for the structure optimization on the PC clusters 1400 and the calculation of the entropy energies on the distributed shared clusters 1500 are carried out at the same time, the processing/control unit 102 can determine, by referring to the map shown in FIG. 16, the number N^{PC}_{PE} of the computing units 1403 of the PC clusters 1400 and the number N^{DSM}_{PE} of the computing units 1503 of the distributed shared clusters 1500, which equalize the calculation process time for the structure optimization and the calculation process time for the entropy energies.

### Third Embodiment

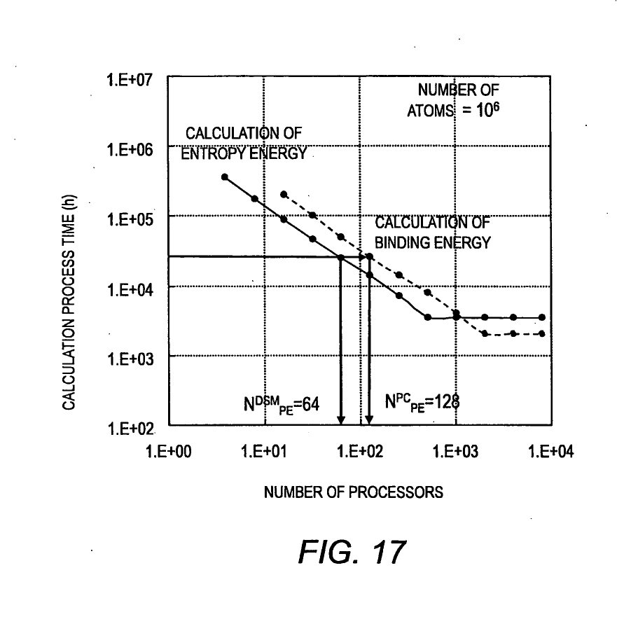

A description will now be given of a third embodiment of this invention shown in FIG. 17 in which a relationship between the number of processors and the calculation process time is shown with the content of the calculation process as parameter, and the number of atoms is 10⁶. FIG. 17 shows, in the design system of binding energy for polymer molecule, another example of the dependency of the calculation process time Tnew employing the macro process steps A to D on the numbers N^{PC}_{PE} and N^{DSM}_{PE} of computing units. This example shows a case in which the number of atoms for which the calculation is carried out is larger than the number of atoms according to the second embodiment shown in FIG. 16.

In FIG. 17, the number Mc of the compounds is 1, the number Nw′+Np of atoms is 10⁶, the relationship Np=Nw′/3 holds, the number N^{h} of calculated binding energies according to the structure optimization is 100, and the number N^{S} of calculated entropy energies according to the normal frequency analysis is 100. The process time N^{h}/N^{PC}_{PE}×H(Nw′+Np)Nem for calculating the binding energy according to the structure optimization is indicated by a broken line, and the process time N^{S}/N^{DSM}_{PE}×S(Np) for calculating the entropy energy according to the normal frequency analysis is indicated by a solid line. In order to equally disperse the load by means of the parallel processing, when, as the number of the computing units, the number N^{PC}_{PE} of the computing units 1403 of the PC clusters 1400 is 128, and the number N^{DSM}_{PE} of the computing units 1503 of the distributed shared clusters 1500 is 64, the calculation process time can be equalized.

In other words, by setting, for the number of atoms for which the calculation is carried out as shown in FIGS. 16 and 17, the calculation process time in terms of the type and number of the computing units for the types of calculation, it is possible to easily obtain the proper number of computing units and the proper calculation process time depending on the amount of the calculation process.

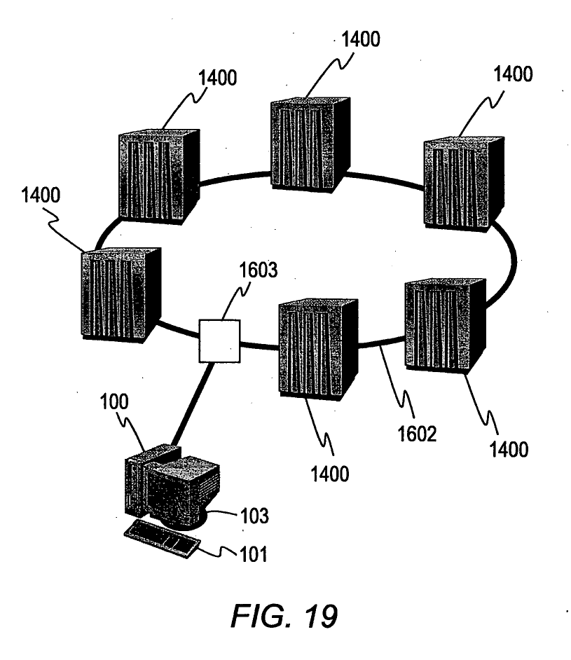

Though the above-mentioned example in which, by employing the distributed shared clusters 1500 constructed by the highly-parallel computers and the PC clusters 1400 constructed by the personal computers, the program 1410 for calculating the binding energy according to the structure optimization and the program 1510 for calculating the entropy according to the normal frequency analysis are executed is shown, as shown in FIG. 19, the program 1410 for calculating the binding energy and the program 1510 for calculating the entropy may be executed on the PC clusters 1400, or the program 1410 for calculating the binding energy and the program 1510 for calculating the entropy may be executed on a single computer (personal computer 100, for example). It should be noted that FIG. 19 is a block diagram showing another example of the computer system.

As described above, this invention can be applied to a drug design system, and an analysis system and an analysis software program for measuring an interaction between biopolymers, such as a molecular probe, a mass analysis, and a protein chip, each of which is provided for predicting a free energy of a polymer.

While the present invention has been described in detail and pictorially in the accompanying drawings, the present invention is not limited to such detail but covers various obvious modifications and equivalent arrangements, which fall within the purview of the appended claims.

What is claimed is:

1. A design system of binding energy for polymer molecule, comprising a computer including a processor for carrying out a calculation process, a memory system for storing a program and data, an input system for inputting data on a complex constructed by a protein in a hydration state and a compound, a control unit for obtaining a minimum value of a free energy of the complex based on the input data, and an output system for outputting a result of the calculation carried out by the control unit,
wherein the control unit comprises:
an input unit for receiving, from the input system, a reference binding structure of the complex constructed by the protein in the hydration state and the compound, a search region for a candidate binding structure of the complex, the number of candidate binding structures for which a binding energy according to structure optimization is calculated, and the number of candidate binding structures for which an entropy energy is calculated according to normal frequency analysis;
an unbound protein optimum structure setting unit for setting an optimum structure of an unbound protein in a solution;
a candidate binding structure calculation unit for, by removing water molecules from the protein, and searching for a local minimum value in the binding energy in the search region, selecting N^{h} candidate binding structures between the protein and the compound;
a structure optimization unit for adding the removed water molecules, carrying out structure optimization for the compound, protein, and complex in the solution, selecting N^{S} candidate binding structures, and carrying out, for the selected candidate binding structures, structure optimization for the protein and the compound in the solution;
an entropy processing unit for calculating entropy, in the solution, of the candidate binding structures for which the structure optimization has been carried out; and
a complex determination unit for determining a complex structure of a candidate binding structure having a minimum free energy, which is a sum of the binding energy and the entropy energy.

2. The design system of binding energy for polymer molecule according to claim 1, comprising a second computer coupled to the computer via a network and including a processor for carrying out a calculation process, and a memory system for storing a program and data, the second computer carrying out an arithmetic operation according to an instruction issued by the computer, wherein:
the candidate binding structure calculation unit comprises:
a water molecule removal unit for removing the water molecules surrounding the unbound protein and storing a water molecule structure in the hydration state;
a search execution unit for setting a search region for the candidate binding structure between the unbound protein and the compound obtained by removing the water molecules, and the number of decomposed regions of the search region to determine the candidate binding structures with a local minimum binding energy; and
a candidate selection unit for selecting N^{h} candidate binding structures, which are close in configuration structure of the compound with respect to the input reference binding structure of the complex, from the candidate binding structures determined by the search execution unit;
the structure optimization unit comprises:
a water molecule adding unit for adding the water molecules removed by the water molecule removal unit to the candidate binding structures selected by the candidate selection unit, and removing water molecules adjacent to atoms of the compound;
a binding energy calculation unit for, for the N^{h} candidate binding structures in the solution selected by the candidate selection unit, instructing the second computer to carry out the structure optimization for obtaining the optimum structures of the candidate binding structures, and the calculation of the binding energy, and receiving optimum structures of the complex of the candidate binding structures in the solution, and the binding energies, which are results of the calculation, from the second computer;
an optimum structure selection unit for selecting N^{S} optimum structures of the candidate binding structures received from the second computer having the lowest binding energies;
a compound structure setting unit for one of setting protein structures in the solution obtained by removing the compound from the N^{S} optimum structures of the candidate binding structures in the solution, and adding water molecules to and manipulating the protein structures, and setting compound structures in the solution obtained by removing the protein from the N^{S} optimum structures of the candidate binding structures in the solution, and adding water molecules to and manipulating the compound structures; and
an optimum structure calculation unit for, for one of the protein structures in the solution of the N^{S} candidate binding structures in the solution, and the compound structures in the solution of the N^{S} candidate binding structures in the solution, instructing the second computer to carry out the calculation for the structure optimization, and receiving the optimum structures of the one of the protein and the compound of the candidate binding structures in the solution as a result of the calculation from the second computer; and
the entropy processing unit comprises an entropy calculation execution unit for instructing the second computer to carry out calculation of the entropy energies according to the normal frequency analysis for the complex, and the one of the protein and the compound in the solution of the N^{S} candidate binding structures in the solution, and receiving from the second computer the entropy of the complex, and the one of the protein and the compound of the candidate binding structures in the solution, which are calculation results.

3. The design system of binding energy for polymer molecule according to claim 2, wherein the unbound protein optimum structure setting unit carries out a calculation of the structure optimization only once for the unbound protein in the solution.

4. The design system of binding energy for polymer molecule according to claim 2, wherein the search execution unit sets, as the search region for the binding structure between the structure of the unbound protein and the compound of the reference binding structure, a translational search region, a rotational search region, and the number of the decomposed regions of the search region, and determines the candidate binding structure which has a local minimum value in the binding energy between the protein and the compound.

5. The design system of binding energy for polymer molecule according to claim 2, wherein the candidate selection unit compares a structure of the compound in the reference binding structure and a structure of the compound in the candidate binding structures to select N^{h} candidate binding structures which have a small mean square error in atomic coordinate of the structure of the compound.

6. The design system of binding energy for polymer molecule according to claim 2, wherein the water molecule adding unit adds the water molecule structure stored by the water molecule removal unit to the selected N^{h} candidate binding structures, and, when an interaction energy between an atom of the compound and the water molecule is higher than a threshold energy, removes the adjacent water molecule.

7. The design system of binding energy for polymer molecule according to claim 2, wherein the water molecule adding unit adds the water molecule structure stored by the water molecule removal unit to the selected N^{h} candidate binding structures, and, when one of a distance between an atom of the protein and the water molecule, and a distance between an atom of the compound and the water molecule is equal to or more than a predetermined value rp, removes the water molecule to reduce the number of the water molecules to Nw′.

8. The design system of binding energy for polymer molecule according to claim 2, wherein:
the second computer comprises a PC cluster including a plurality of computing units for carrying out parallel processing; and
the binding energy calculation unit distributes, based on the number N^{h} of the selected candidate binding structures in the solution and the number N^{PE}_{PC} of the plurality of computing units set in advance, N^{h}/N^{PE}_{PC} of the candidate binding structures to each of the plurality of computing units.

9. The design system of binding energy for polymer molecule according to claim 2, wherein:
the second computer comprises a PC cluster including a plurality of computing units for carrying out parallel processing; and
the optimum structure calculation unit distributes, based on the number N^{PE}_{PC} of the plurality of computing units set in advance, N^{S}/N^{PE}_{PC} of the protein structures in the solution of the N^{S} candidate binding structures in the solution to each of the plurality of computing units.

10. The design system of binding energy for polymer molecule according to claim 2, wherein:
the second computer comprises a PC cluster including a plurality of computing units for carrying out parallel processing; and
the optimum structure calculation unit distributes, based on the number N^{PE}_{PC} of the plurality of computing units set in advance, N^{S}/N^{PE}_{PC} of the compound structures in the solution of the N^{S} candidate binding structures in the solution to each of the plurality of computing units.

11. The design system of binding energy for polymer molecule according to claim 2, wherein the entropy calculation execution unit calculates, when the entropy energy is calculated according to the normal frequency analysis for the selected N^{S} optimum structures of the complex in the solution, the selected N^{S} optimum structures of the protein in the solution, and the selected N^{S} optimum structures of the compound in the solution, a mass of the water molecule set by a predetermined value.

12. The design system of binding energy for polymer molecule according to claim 2, wherein:
the second computer comprises a parallel computer including a plurality of computing units having a distributed shared memory for carrying out parallel processing; and
the entropy calculation execution unit distributes, based on the number N^{DSM}_{PE} of the computing units set in advance, N^{S}/N^{DSM}_{PE} of the selected N^{S} optimum structures of the complex in the solution, the selected N^{S} optimum structures of the protein in the solution, the selected N^{S} optimum structures of the compound in the solution to each of the plurality of computing units to be caused to carry out the calculation of the entropy energies.

13. The design system of binding energy for polymer molecule according to claim 2, wherein the entropy calculation execution unit carries out the calculation of the entropy energies for the selected N^{S} optimum structures of the complex in the solution according to the normal frequency analysis simultaneously with the calculation for the structure optimization of the protein structures in the solution of the N^{S} candidate binding structures in the solution by the optimum structure calculation unit.

14. The design system of binding energy for polymer molecule according to claim 13, wherein:
the second computer comprises a parallel computer including a plurality of computing units having a distributed shared memory for carrying out parallel processing, and a PC cluster including a plurality of computing units for carrying out parallel processing;
the entropy calculation execution unit instructs the parallel computer to carry out the calculation of the entropy energies of the selected N^{S} optimum structures of the complex in the solution according to the normal frequency analysis;
the optimum structure calculation unit instructs the PC cluster to calculate the structure optimization of the protein structures in the solution of the N^{S} candidate binding structures in the solution; and
the selection unit determines, based on a table set in advance so that a calculation period of time for the entropy energies and a calculation period of time for the structure optimization are equalized, the number N^{PC}_{PE} of the plurality of computing units of the PC cluster and the number N^{DSM}_{PE} of the plurality of computing units of the parallel computer.

15. A design method of binding energy for polymer molecule, for obtaining, with a computer comprising a processor for carrying out a calculation process, a memory system for storing a program and data, and an input system for inputting data on a complex including a protein in the hydration state and a compound, a minimum value of a free energy of the complex based on the input data, the design method of binding energy for polymer molecule comprising:
receiving, from the input system, a reference binding structure of the complex including the protein in a hydration state and the compound, a search region for a candidate binding structure of the complex, the number of candidate binding structures for which a binding energy according to structure optimization is calculated, and the number of the candidate binding structures for which an entropy energy is calculated according to normal frequency analysis;
setting an optimum structure of an unbound protein in a solution;
after removing water molecules from the protein, searching for a local minimum value in the binding energy in the search region and selecting N^{h} candidate binding structures between the protein and the compound;
adding the removed water molecules, carrying out structure optimization for the compound, protein, and complex in the solution, selecting N^{S} candidate binding structures, and carrying out, for the selected candidate binding structures, structure optimization for the protein and the compound in the solution;
calculating entropy, in the solution, of the candidate binding structures for which the structure optimization has been carried out; and
determining a complex structure of a candidate binding structure having a minimum free energy, which is a sum of the binding energy and the entropy energy.

16. The design method of binding energy for polymer molecule according to claim 15, wherein:
the searching for a local minimum value in the binding energy in the search region and selecting N^{h} candidate binding structures between the protein and the compound comprises:
removing water molecules surrounding the unbound protein to store a water molecule structure in the hydration state;
setting a search region for the candidate binding structure between the unbound protein and the compound obtained by removing the water molecules, and the number of decomposed regions of the search region to determine the candidate binding structures with a local minimum binding energy; and
selecting N^{h} candidate binding structures, which are close in configuration structure of the compound with respect to the input reference binding structure of the complex, from the determined candidate binding structures;
the adding the removed water molecules, carrying out structure optimization for the compound, protein, and complex in the solution, selecting N^{S} candidate binding structures, and carrying out, for the selected candidate binding structures, structure optimization for the protein and the compound in the solution comprises:
adding the removed water molecules to the selected candidate binding structures, and removing water molecules adjacent to atoms of the compound;
for the selected N^{h} candidate binding structures in the solution, instructing a second computer to carry out the structure optimization for obtaining the optimum structures of the candidate binding structures, and the calculation of the binding energy, and receiving optimum structures of the complex of the candidate binding structures in the solution, and the binding energies, which are calculation results, from the second computer;
selecting N^{S} optimum structures of the candidate binding structures received from the second computer having the lowest binding energies;
setting one of protein structures in the solution obtained by removing the compound from the N^{S} optimum structures of the candidate binding structures in the solution, and adding water molecules to and manipulating the protein structure, and compound structures in the solution obtained by removing the protein from the N^{S} optimum structures of the candidate binding structures in the solution, and adding water molecules to and manipulating the compound structure; and
for one of the protein structures in the solution of the N^{S} candidate binding structures in the solution and the compound structures in the solution of the N^{S} candidate binding structures in the solution, instructing the second computer to carry out the calculation for the structure optimization, and receiving the optimum structures of one of the protein and the compound of the candidate binding structures in the solution as a result of the calculation from the second computer; and
the calculating entropy, in the solution, of the candidate binding structures for which the structure optimization has been carried out comprises instructing the second computer to carry out calculation of the entropy energies according to the normal frequency analysis for the complex, and the one of the protein and the compound in the solution of the N^{S} candidate binding structures in the solution, and receiving from the second computer the entropy of the complex, and the one of the protein and the compound of the candidate binding structures in the solution, which are results of the calculation.

17. A machine-readable medium storing a program controlling a computer comprising a processor for executing a calculation process, a memory system for storing a program and data, and an input system for inputting data on a complex including a protein in a hydration state and a compound, to obtain a minimum value of a free energy of the complex based on the input data, the program controlling the computer to execute the procedures of:
receiving, from the input system, a reference binding structure of the complex including the protein in a hydration state and the compound, a search region for a candidate binding structure of the complex, the number of the candidate binding structures for which a binding energy according to structure optimization is calculated, and the number of the candidate binding structures for which an entropy energy is calculated according to normal frequency analysis;
setting an optimum structure of an unbound protein in a solution;
after removing water molecules from the protein, searching for a local minimum value in the binding energy in the search region and selecting N^{h} candidate binding structures between the protein and the compound;
adding the removed water molecules, carrying out structure optimization for the compound, protein, and complex in the solution, selecting N^{S} candidate binding structures, and carrying out, for the selected candidate binding structures, structure optimization for the protein and the compound in the solution;
calculating entropy, in the solution, of the candidate binding structures for which the structure optimization has been carried out; and
determining a complex structure of a candidate binding structure having a minimum free energy, which is a sum of the binding energy and the entropy energy.

18. The memory medium storing a program according to claim 17, wherein:
the searching for a local minimum value in the binding energy in the search region and selecting N^{h} candidate binding structures between the protein and the compound comprises the procedures of:
removing water molecules surrounding the unbound protein to store a water molecule structure in the hydration state;
setting a search region for the candidate binding structure between the unbound protein and the compound obtained by removing the water molecules, and the number of decomposed regions of the search region to determine the candidate binding structures with the local minimum binding energy; and
selecting N^{h} candidate binding structures, which are close in configuration structure of the compound with respect to the input reference binding structure of the complex, from the determined candidate binding structures;
the adding the removed water molecules, carrying out structure optimization for the compound, protein, and complex in the solution, selecting N^{S} candidate binding structures, and carrying out, for the selected candidate binding structures, structure optimization for the protein and the compound in the solution comprises the procedures of:
adding the removed water molecules to the selected candidate binding structures, and removing water molecules adjacent to atoms of the compound;
for the selected N^{h} candidate binding structures in the solution, instructing a second computer to carry out the structure optimization for obtaining the optimum structures of the candidate binding structures, and the calculation of the binding energy, and receiving optimum structures of the complex of the candidate binding structures in the solution, and the binding energies, which are results of the calculation, from the second computer;
selecting N^{S} optimum structures of the candidate binding structures received from the second computer having the lowest binding energies;
setting one of protein structures in the solution obtained by removing the compound from the N^{S} optimum structures of the candidate binding structures in the solution, and adding water molecules to and manipulating the protein structure, and compound structures in the solution obtained by removing the protein from the N^{S} optimum structures of the candidate binding structures in the solution, and adding water molecules to and manipulating the compound structure; and
for one of the protein structures in the solution of the N^{S} candidate binding structures in the solution, and the compound structures in the solution of the N^{S} candidate binding structures in the solution, instructing the second computer to carry out the calculation for the structure optimization, and receiving the optimum structures of one of the protein and the compound of the candidate binding structures in the solution as a result of the calculation from the second computer; and
the calculating entropy, in the solution, of the candidate binding structures for which the structure optimization has been carried out comprises the procedures of instructing the second computer to carry out calculation of the entropy energies according to the normal frequency analysis for the complex, and the one of the protein and the compound in the solution of the N^{S} candidate binding structures in the solution, and receiving from the second computer the entropy of the complex, and the one of the protein and the compound of the candidate binding structures in the solution, which are results of the calculation.
